(19) United States
(12) Patent Application Publication
(10) Pub. No.: US 2026/0121360 A1
(43) Pub. Date: Apr. 30, 2026

(54) Temperature Monitoring and Safety Control for an Electrical Outlet

(71) Applicant: Azara Energy, LLC, Fort Wayne, IN (US)

(72) Inventors: Michael Zwach, Fort Wayne, IN (US); Justin Siples, Fairplay, CO (US)

(21) Appl. No.: 19/371,468

(22) Filed: Oct. 28, 2025

Related U.S. Application Data
(60) Provisional application No. 63/713,296, filed on Oct. 29, 2024.

(51) Int. Cl. H01R 13/713; H01R 24/78; H01R 107/00

(52) U.S. Cl. CPC H01R 13/7137; H01R 13/7135; H01R 24/78; H01R 2107/00; H01R 2201/26

(57) ABSTRACT

Temperature monitoring and safety control for an electrical outlet is disclosed. An electrical wall receptacle may incorporate temperature monitoring and electrical disconnect that may be used to prevent an electrical outlet from overheating, such as while operating under relatively high current applications for prolonged periods. At least one temperature sensor may be used to indicate temperature associated with one or more terminals. A controller may receive an indication of a measured temperature, and based on the indicated temperature, control at least one switch to either connect or disconnect one or more electrical connections between an input power and output power terminals.

### CROSS-REFERENCE TO RELATED APPLICATIONS

This application claims the benefit of U.S. Provisional Application No. 63/718,296 filed on Oct. 29, 2024. The above-referenced application is hereby incorporated by reference in its entirety.

### TECHNICAL FIELD

Aspects of the disclosure relate to the supply of electricity via an electrical outlet.

### BACKGROUND

Electrical outlets are designed to operate under certain voltage and current limitations. Many uses of electricity via electrical outlets are within such voltage and current limitations. Circuit breakers are used to protect electrical systems from surges in power and excessive/over current that could otherwise damage electrical equipment receiving electricity via electrical outlets. Circuit breakers do not sufficiently protect electrical outlets, or electrical equipment connected thereto, from thermal failure due to prolonged use by applications that draw a relatively high current.

### SUMMARY

The following presents a summary of the disclosure in order to provide a basic understanding of some aspects of the disclosure.

Temperature monitoring and safety control for an electrical outlet is disclosed. An electrical wall receptacle may incorporate temperature monitoring and/or electrical disconnect operation(s) that may be used to prevent an electrical outlet from overheating while operating under relatively high current applications for prolonged periods. Example applications may include, but are not limited to, charging electric, plug-in hybrid, and/or recreational vehicles, and/or operating an electronic device requiring a relatively high current for an extended period of time. While temperature monitoring and safety control described herein may be incorporated into a variety of products, an example apparatus may comprise an electrical enclosure (such as a dual-gang/2-gang wall mount enclosure device, an external wall mount device, a conduit box, a junction box, a receptacle assembly, and/or any certified electrical enclosure) that may house a National Electrical Manufacturers Association (NEMA) 14-50 outlet, one or more thermal monitoring components, and/or one or more disconnect components. Thermal sensors may be placed within the apparatus to provide accurate temperature information for wiring therein. In the event that a high temperature event is detected, which may otherwise lead to a safety risk if left unaddressed, the apparatus may actuate one or more integrated electrical switches that may stop current flow and thereby prevent catastrophic failure due to thermal heating. The apparatus may optionally be configured to communicate information, such as alerts, control information, and/or data, that may assist in a determination of whether a progressive trend is occurring such that corrective action (e.g., repair or replacement) may be taken before a catastrophic thermal event occurs.

These features, along with many others, are described in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an example electric vehicle (EV) charging configuration;

FIG. 2 shows various potential failure points for an electrical system, including relating to EV charging;

FIG. 3A shows an example of an electrical outlet and a side view of an EV charger;

FIG. 3B shows an example EV charger coupled to an electrical outlet;

FIG. 4A shows an example apparatus and system for an electrical outlet with temperature monitoring and safety control;

FIG. 4B shows an example front-view of the apparatus and system of FIG. 4A;

FIG. 4C shows an example back-view of the apparatus and system of FIG. 4A;

FIG. 4D shows an example top-view of the apparatus and system of FIG. 4A;

FIG. 4E shows an example side-view of the apparatus and system of FIG. 4A; and

FIG. 4F shows an example apparatus and system for an electrical outlet with temperature monitoring and safety control;

FIG. 4G shows an example front-view of the apparatus and system of FIG. 4F;

FIG. 4H shows an example back-view of the apparatus and system of FIG. 4F;

FIG. 4I shows an example top-view of the apparatus and system of FIG. 4F;

FIG. 4J shows an example side-view of the apparatus and system of FIG. 4F;

FIG. 4K shows additional example details of the apparatus and system of FIG. 4F;

FIG. 4L shows additional example details of a portion of the apparatus and system of FIG. 4F;

FIG. 4M shows additional example details of a portion of the apparatus and system of FIG. 4F;

FIG. 4N shows additional example details of the apparatus and system of FIG. 4F within an enclosure.

FIG. 5A shows an example method for temperature monitoring and safety control for an electrical outlet;

FIG. 5B shows an example method for temperature monitoring and safety control for an electrical outlet;

FIG. 6A and FIG. 6B show example back-side and front-side views, respectively, of an example of an example apparatus and system for an electrical outlet with temperature monitoring and safety control; and

FIG. 6C shows additional example details of the apparatus and system of FIGS. 6A and 6B.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

Electrical outlet failure may occur for various reasons. In some examples, failure can occur due to a voltage surge and/or due to installation error such as failing to properly secure wiring. Other types of failures of an electrical outlet may occur over a time period of use after installation, and such failures may not be caused by a sudden event such as a voltage surge in an electrical supply. For example, each time that an electrical outlet is used to draw a relatively high amount of current (such as to charge a vehicle or to power an appliance) over a relatively long duration (e.g., several hours or more) at a relatively high duty cycle, wiring carrying the current experiences a fatigue. For example, level 2 charging for an EV may require approximately 40-50 Amps of current from a 220-277 VAC electrical supply over a duration of approximately six to twelve hours, depending on a variety of factors (e.g., battery size, amount of battery depletion upon initiating charging, power level to which the battery is to be charged, rating of charger, and charging capability of vehicle), which may cause fatigue on wiring within or near the electrical outlet (e.g., at receptacle terminals, connection points, bends, etc.). This fatigue may cause one or more connections of wiring in the electrical outlet to loosen. Loosening of the connection(s) may be the result of a heating cycle, whereby a wire and/or a connection to a wire will expand as it heats during a charge cycle and contract as it cools after the charge cycle. Such expansion/contraction may result in a torque being lessened on the wire and/or connection, and/or in a resistance building on the receptacle and/or connection(s) of the electrical outlet, which may result in an increase in heat within the receptacle (e.g., at the connection(s)). This heating can cause problems such as arcing within the electrical outlet, which may cause issues such as sparks/fire, melting of one or more connection(s) and/or terminal(s), and/or failure of the receptacle.

Preventative measures may be taken such as periodic (e.g., monthly, quarterly, biannually) inspection of electric outlets being used for relatively high current applications, such as EV charging, and/or periodic physical tightening/torquing of wire connections. However, preventative measures may be costly and/or time-consuming to perform on a long-term basis. In addition, preventative measures may not identify all potential problems before they occur. For example, failure due to excessive heating may not occur within an electrical outlet until a long period after installation, such as after many thermal cycles (e.g., 50, 100, 200 charging cycles or more), following extended use over a relatively long duration (e.g., several months or years). As a result, wire fatigue experienced over time may not be detected upon inspection until after a failure occurs, and failure of conventional electric outlets when used for relatively high current applications may occur unexpectedly and without warning.

EVs and/or EV chargers may include at least some internal mechanisms, such as thermal monitoring and/or disconnect operations, that may reduce a likelihood of damage to the EV and/or the EV charger resulting from a charging operation. However, such mechanisms are insufficient to prevent failure of an electrical outlet into which the EV charger, and in turn the EV, is electrically connected for a charging operation. For example, a temperature measured within the EV charger and/or within the EV may be within a range considered to be safe for the EV charger and/or EV, while at the same time a higher/unsafe temperature may be experienced within the electrical outlet during a charging operation. As a result, EVs and EV chargers have been unable to sufficiently prevent catastrophic failures due to a thermal event within or near an electrical outlet. Additionally, even if some EVs and/or EV chargers were to include at least some internal mechanisms with thermal monitoring and/or disconnect operations, an electrical outlet that may be used for charging different EVs and/or with different EV chargers (such as in a rental unit, an apartment, a multi-dwelling unit, an office location, and/or any other location that may have different users with different equipment) may be used with EVs and/or with EV chargers (or other equipment) that may lack such safety features and that may lead to increased risk of failure of an electrical outlet.

At least some electrical outlets may be configured with safety mechanisms such as for arc faults and ground faults. As examples, arc fault circuit interrupts (AFCIs) may be used to protect from arc faults, and/or ground-fault circuit interrupt (GFCI) outlets may be used to help reduce a risk of electrocution. Arcing may occur, for example, when an electrical current jumps a gap (e.g., air, dust, or unintended material) between two electrodes and can connect via one or more unintended paths, such as a damaged wire. However, AFCIs are designed to protect from arc faults, and GFCIs operate based on detection of leakage current between an electrical supply line and ground. Neither of these approaches include thermal monitoring, and neither of these approaches, by themselves or in combination with the other, adequately prevents thermal failures occurring at points of connection for electrical supply lines at an electrical receptacle, for example, due to heating within the receptacle that may result from extended use with a relatively high current.

Additionally, thermal monitoring may be performed along a wire such as with thermal overload relays. However, thermal monitoring along a wire that is not at a terminal or point of connection of that wire to a receptacle is insufficient to prevent thermal-based failure of an electrical receptacle, which may experience different temperature levels than at other points of a wire. Additionally, devices such as thermal overload relays may not be of a practical size to accommodate their inclusion within an electrical outlet in order to provide monitoring of terminals and/or points of connection of an electrical receptacle. Similarly, thermal monitoring at or near a receptacle, but not specific to any particular electrical supply line within the receptacle, is insufficient to prevent thermal-based failure of the receptacle. As an example, a terminal and/or point of connection for a first supply line (e.g., a first 110-135 VAC supply in a NEMA 14-50 receptacle) may experience a potentially damaging/dangerous level of heat while a terminal and/or point of connection for a second supply line (e.g., a second 110-135 VAC supply in a NEMA 14-50 receptacle) of the same receptacle may not experience the same level of heat (e.g., it may experience a significantly lower temperature). As a result, a measured temperature at or near the receptacle, but not specific to either supply line, may not indicate an overall potentially damaging/dangerous level of heat, even though the level of heat at the first supply line may result in an overall failure of the receptacle (e.g., at a terminal and/or point of connection associated with the first supply line). For example, thermal monitoring at or near the receptacle, but not specific to either supply line, may correspond to an average, materials-based temperature of a sum of the supply line temperatures, but not an actual temperature of either of the supply lines. As described herein, solutions are provided that provide improved temperature monitoring and safety control for an electrical outlet that overcome the above-noted deficiencies.

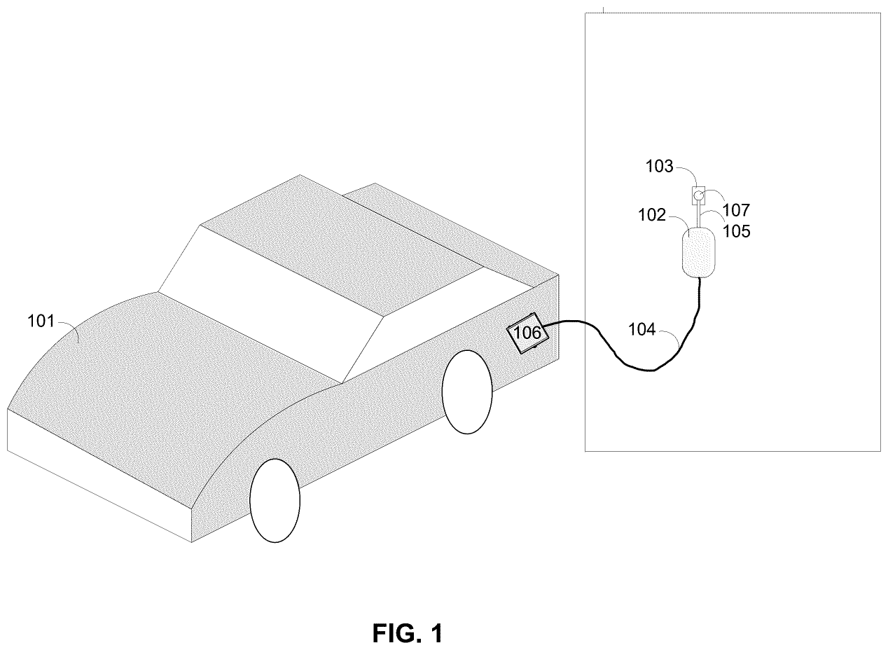

FIG. 1 shows an example electric vehicle (EV) charging configuration. An EV charging configuration 100 may comprise an EV 101 coupled to a charging source 110. The charging source 110 may comprise a home charging source, a multi-dwelling charging source, an office charging source, a retail/commercial charging source, and/or any other charging source. In the example shown in FIG. 1, the charging source 110 may originate from a home, such as from electricity generated from an electrical grid, an onsite electrical source (e.g., solar, wind, geothermal, etc.), and/or an onsite electrical storage source (e.g., battery/batteries) which may be coupled to an inverter for providing alternating current (AC). An AC electrical supply may be provided via electrical wiring and/or cable(s) that may be passed through conduit. The conduit may be located behind a wall of the charging source 110, under flooring, and/or along a ceiling. The conduit may terminate at an electrical outlet 103. The electrical outlet 103 may comprise one or more outlets, connectors, and/or sockets. The electrical outlet 103 may be configured with one or more temperature monitoring and/or safety control mechanisms as described further herein.

The electrical outlet 103 may provide any range of voltage levels with any current level. For example, for a charging source 110 that is a home charging source, a common voltage level may be approximately 110-135 VAC. Such a 110-135 VAC electrical supply may provide a voltage level at an approximate level (e.g., 110 VAC, 120 VAC, etc.) or a range of voltage levels (e.g., 110-115 VAC, 110-120, etc.). Using this type of 110-135 VAC electrical supply for EV charging may be referred to as level 1 EV charging.

In at least some examples, a charging source 110 may be configured for what may be referred to as level 2 EV charging. Level 2 charging may be provided by a common voltage level at approximately 220-277 VAC. In at least some examples, a 220-277 VAC electrical supply may be provided as the charging source 110. The 220-277 VAC electrical supply may use two lead wires that each separately supplies approximately half of the overall voltage (e.g., 110-135 VAC) to yield a net level of approximately 220-277 VAC. Such a 220-277 VAC electrical supply may provide a voltage level at an approximate level (e.g., 220 VAC, 245 VAC, etc.) or a range of voltage levels (e.g., 220-240 VAC, 235-250 VAC, etc.).

The EV charging configuration 100 may comprise the EV 101 being coupled to the charging source 110 via an EV charger 102. While only one EV is shown as EV 101, the EV charging configuration 100 may comprise any number of EVs that may be configured for charging via one or more electrical outlets 103 and/or via one or more EV chargers 102. The EV charger 102 may be coupled to, and/or may comprise as an integral component, an input cable 105. The input cable 105 may comprise a plug 107 that electrically connects the EV charger 102 to the electrical outlet 103. The EV charger 102 may be (additionally) coupled to, and/or may comprise as an integral component, an output cable 104. The output cable 104 may comprise a plug and/or a connector (not shown) that electrically connects to the EV 101 at a charging connection 106 of the EV 101. Additionally or alternatively, the output cable 104, and/or the connector of the output cable 104, may electrically connect to one or more adapters that may enable the EV charger 102 to charge different makes/models of EVs comprising different types of EV charging connections. For example, the plug and/or connector of the output cable 104, and/or one or more adapters coupled thereto, may comprise an input interface and an output interface that may compatible with one or more of any type of EV charging standard/configuration, including but not limited to, a North America Charging Standard (NACS) (e.g., SAE J3400), Combined Charging System (CCS) (e.g., J1772), CHAdeMO, any other standard/configuration, and/or any other type of interface.

The EV charger 102 may be configured to have more than one input cable and/or may be configured to have its input cable 105 capable of being detached and replaced with one or more other input cables. In at least a first example, the input cable 105 may be adapted to electrically connect to a 110-135 VAC outlet and may have internal wiring configured for a current level range corresponding to a 110-135 VAC electrical supply. In at least a second example, the input cable 105 may be adapted to electrically connect to a 220-277 VAC electrical supply and may have internal wiring configured for a current level range corresponding to a 220-277 VAC electrical supply. While these two examples are provided, any other voltage level and/or any current level may be used in at least some other examples.

When the EV charging configuration 100 is in operation, the charging source 110 provides an electrical supply at the electrical outlet 103 (e.g., 110-135 VAC and/or 220-277 VAC). The electrical supply is carried through a plug 107, and the attached input cable 105, into an input of the EV charger 102. The EV charger 102 provides an electrical supply via the output cable 104 to the vehicle 101 at its charging connection 106.

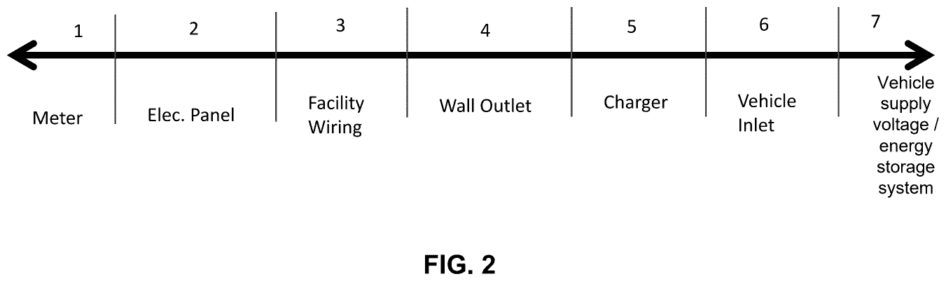

FIG. 2 shows various potential failure points for an electrical system, including relating to EV charging. Successful and safe charging of the EV 101 requires each element in the EV charging configuration 100 to operate without failure. Failure may occur at one or more locations of the EV charging configuration 100. A first point of potential failure shown in FIG. 2 may be at or before an electrical meter and/or an input of electricity into a location (e.g., home, multi-dwelling unit, office, etc.). A consumer of electricity may have limited (if any) control over at least some failures at this first point. A second point of potential failure shown in FIG. 2 may be at an electrical panel, such as blown fuses, tripped circuit breakers, and the like. AFCI, GFCI, and thermal overload relays are examples of devices that may incur and/or address failure(s) at this second point of potential failure. A third point of potential failure shown in FIG. 2 may be within wiring, such as wires overheating (e.g., due to excessive current over a prolonged period). This third point may correspond to input wiring of the electrical outlet 103 described with respect to FIG. 1. A fourth point of potential failure shown in FIG. 2 may be within an electrical outlet (e.g., wall outlet), such as in the electrical outlet 103, which is described further herein. A fifth point of potential failure shown in FIG. 2 may be due to failure of an EV charger (e.g., EV charger 102) including any EV charging cables (e.g., plug 107, input cable 105, output cable 104). A sixth point of potential failure shown in FIG. 2 may be at a vehicle inlet (e.g., at the charging connection 106, at a vehicle adapter/connector, internal vehicle connector(s)/wiring). A seventh point of potential failure shown in FIG. 2 may be due to a failure of the vehicle's supply voltage and/or energy storage system (e.g., battery system). While other points of potential failure may be possible, the seven points of possible failure shown and described with respect to FIG. 2 may correspond to the most likely points of possible failure for EV charging. While temperature monitoring and safety control mechanisms described herein may be applicable for any of these points of failure, examples are described that are particularly applicable (although are not limited) to the fourth point of potential failure within an electrical outlet.

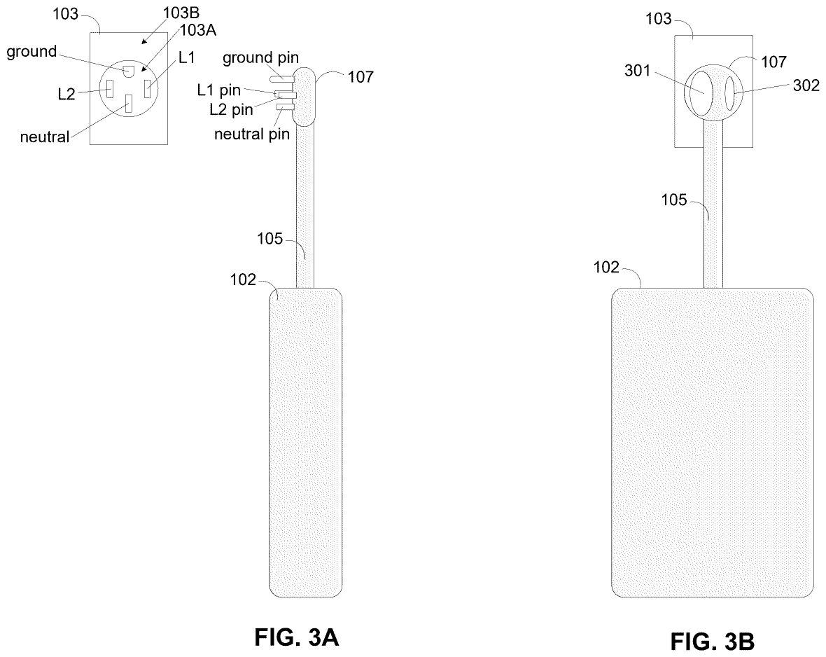

FIG. 3A shows an example of an electrical outlet and a side view of an EV charger. The EV charger 102, input cable 105, plug 107, and the electrical outlet 103 shown in FIG. 3A may correspond to the same numbered elements described with respect to FIG. 1, descriptions of which are incorporated by reference here. While not shown in FIG. 3A, the EV charger 102 may comprise an output cable (e.g., output cable 104, such as shown and described with respect to FIG. 1) and/or a vehicle plug for coupling the EV charger 102 to an EV (e.g., EV 101). The electrical outlet 103 may comprise a receptacle 103A and a faceplate 103B, for example, either as a single unit or as separate/separable components. The receptacle 103A may comprise terminals/connections for a first electrical supply line (e.g., first hot wire/line 1/X) labeled as L1 or X; a second electrical supply line (e.g., second hot wire/line 2/Y) labeled as L2 or Y; a ground; and a neutral. While some examples herein are shown with four terminals, the receptacle 103A may comprise any other number of terminals, including, for example fewer than four terminals. For example, the receptacle 103A may comprise three terminals, such as for a first electrical supply line, a second electrical supply line, and a ground (e.g., in which case a terminal may be omitted for neutral). As another example, the receptacle 103A may comprise two terminals, such as for a first electrical supply line a second electrical supply line (e.g., without ground or neutral). These connections may be configured to receive respective pins of the plug 107 of the EV charger 102, including a first supply pin (e.g., first hot pin/line 1/X) labeled as L1 pin, a second supply pin (e.g., second hot pin/line 2/Y) labeled as L2 pin, a ground pin, and a neutral pin. The electrical outlet 103 may be configured to be a NEMA 14-50 compliant electrical outlet. The plug 107 of the EV charger 105 may be configured to be a NEMA 14-50 compliant plug. As mentioned above, while FIG. 3A shows the receptacle 103A and the plug as corresponding to a four-terminal/pin NEMA 14-50 compliant receptacle and plug, respectively, the receptacle 103A and/or the plug 107 may be configured with any number of terminals/pins in accordance with any other electrical standard. For example, for level 1 charging, the electrical outlet 103 may comprise a three-terminal receptacle for a first electrical supply line, a ground, and a neutral (e.g., for a 110-135 VAC electrical supply).

FIG. 3B shows an example EV charger coupled to an electrical outlet. As described above regarding FIG. 3A, the EV charger 102, input cable 105, plug 107, and the electrical outlet 103 shown in FIG. 3B may correspond to the same numbered elements described with respect to FIG. 1 and/or FIG. 3A, descriptions of which are incorporated by reference here. The EV charger 102 is shown in FIG. 3B from a front view and under an operating condition where the plug 107 is connected to the electrical outlet 103 to receive electricity. Regions 301 and 302 are shown to represent increased heat levels associated with respective areas of the plug 107 (e.g., internal to the plug 107) and/or within the electrical outlet 103 (e.g., at or near points of connection with the plug 107), such as may be observed through heat sensing imaging (e.g., via an infrared thermal imaging camera). For example, as shown, region 301 is larger than region 302 to indicate a greater temperature level within region 301 relative to region 302. Both regions 301 and 302 show temperature levels measurably greater than an ambient temperature in the area of the EV charger 102 and the electrical outlet 103. These increased temperature levels relative to ambient temperature may be due to current flowing through the electrical outlet 103 and the plug 107 (e.g., during EV charging). As an example, current flowing through a second supply line (e.g., via L2) may have higher connection resistance than the current flowing through a first supply line (e.g., via L1), which may result in a higher temperature within region 301 (e.g., around L2) than within region 302 (e.g., around L1).

At some threshold level(s), a temperature may be reached around one or more pins of the plug 107, and/or around one or more terminals of the receptacle 103A, that may cause a failure event at the electrical outlet 103 and/or at the EV charger 102. Such a failure event may correspond to the fourth point of potential failure and/or the fifth point of potential failure described with respect to FIG. 2. For example, a temperature may be reached around the L1 pin and/or the L2 pin of the plug 107, and/or around the L1 terminal and/or L2 terminal of the receptacle 103A, that may exceed safe operating conditions (e.g., leading to equipment/component failure in the electrical outlet 103 and/or in the EV charger 102, and/or potentially leading to catastrophic failure such as fire, explosion, etc.). In at least some examples, a temperature around L1 (e.g., the L1 pin and/or the L1 terminal of the receptacle 103A) may differ from a temperature around L2 (e.g., the L2 pin and/or the L2 terminal of the receptacle 103A). As a result of this potential temperature difference between L1 and L2, temperature-based safety mechanisms associated with an electrical outlet and/or an EV charger that are not specific to a connection point of a single conducting path (e.g., that are not specific to L1 and/or that are not specific to L2) may not be able to satisfactorily prevent potentially dangerous electrical events (e.g., overheating, combustion, melting, etc.) at a point of failure associated with high current applications, such as EV charging. For example, a temperature-based safety mechanism only at one hot wire/connection (e.g., around L1 only) may not sufficiently account for temperature-based failure at a second hot wire/connection (e.g., around L2) that may experience a different temperature level. As described further herein, solutions are provided that provide improved temperature monitoring and safety control for an electrical outlet at a plurality of connection points.

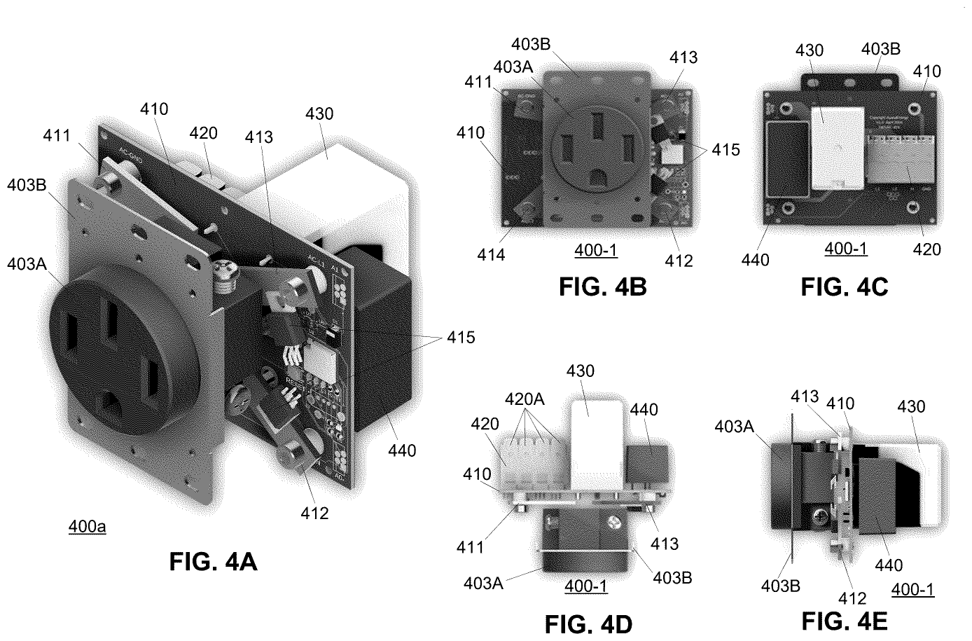

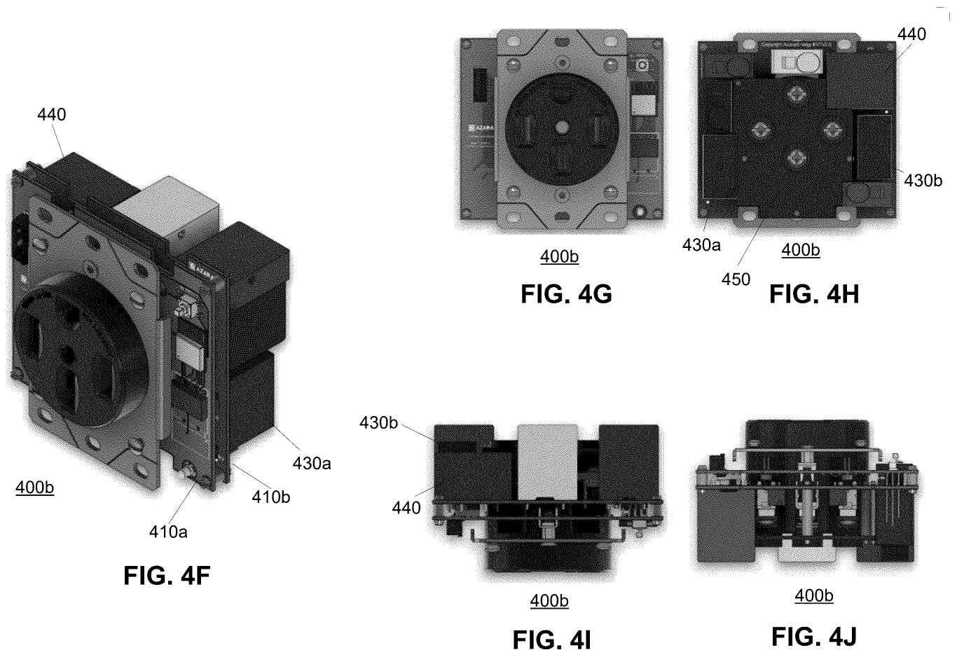

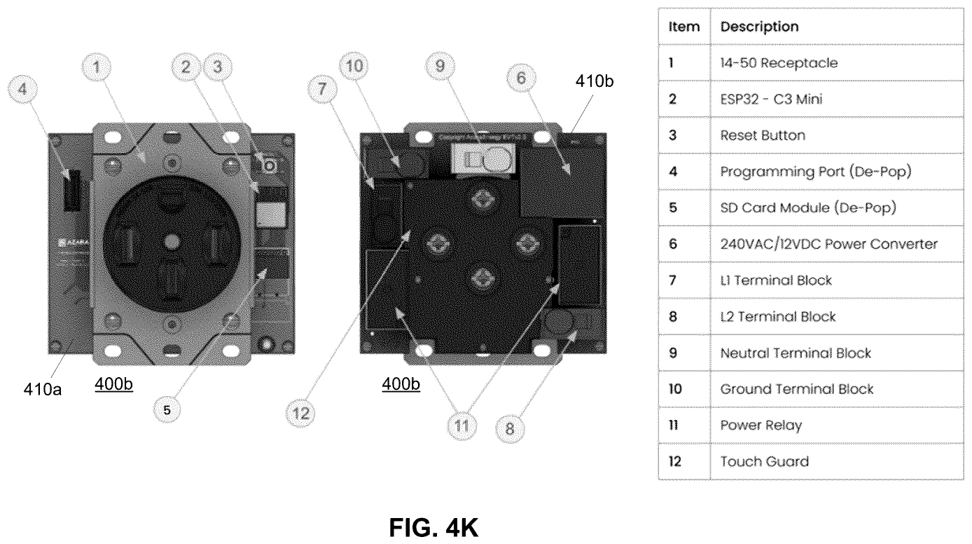

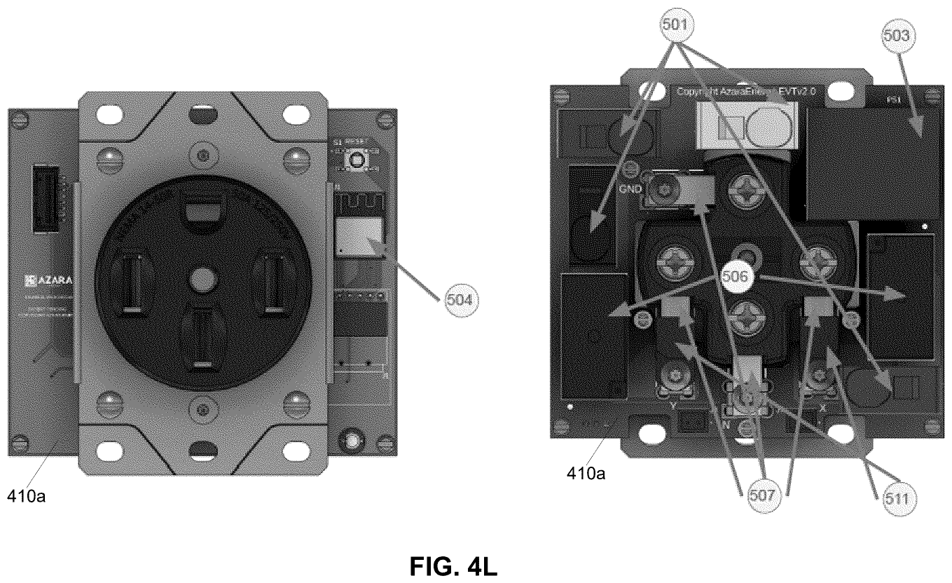

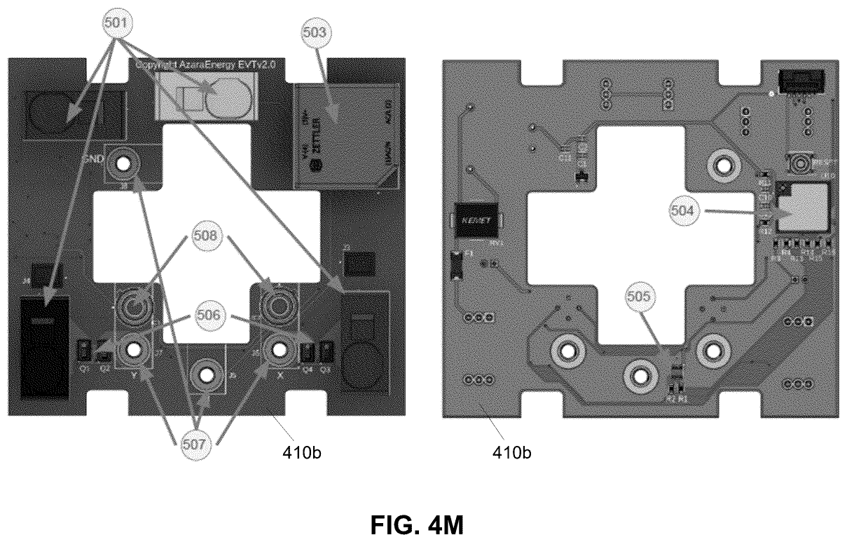

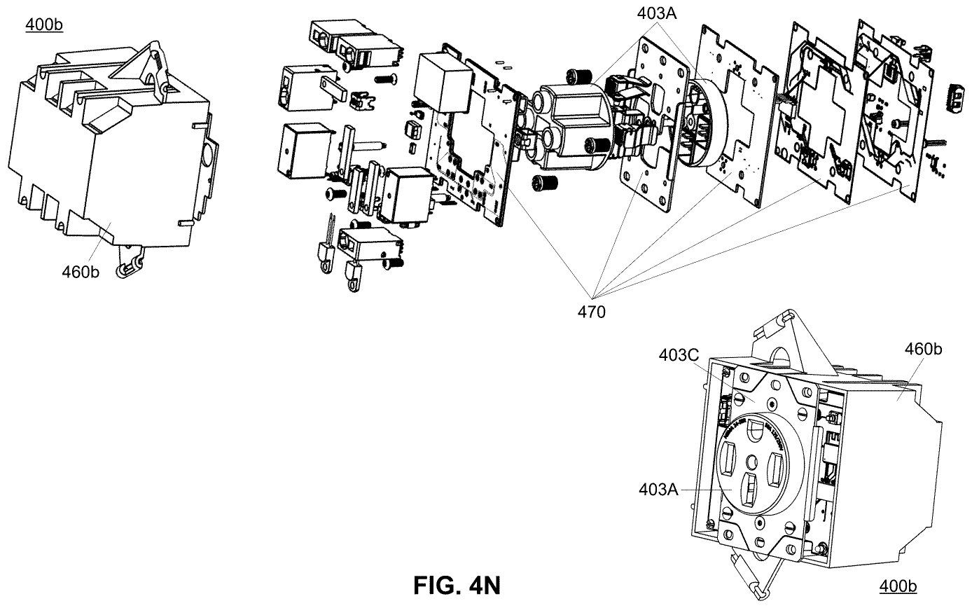

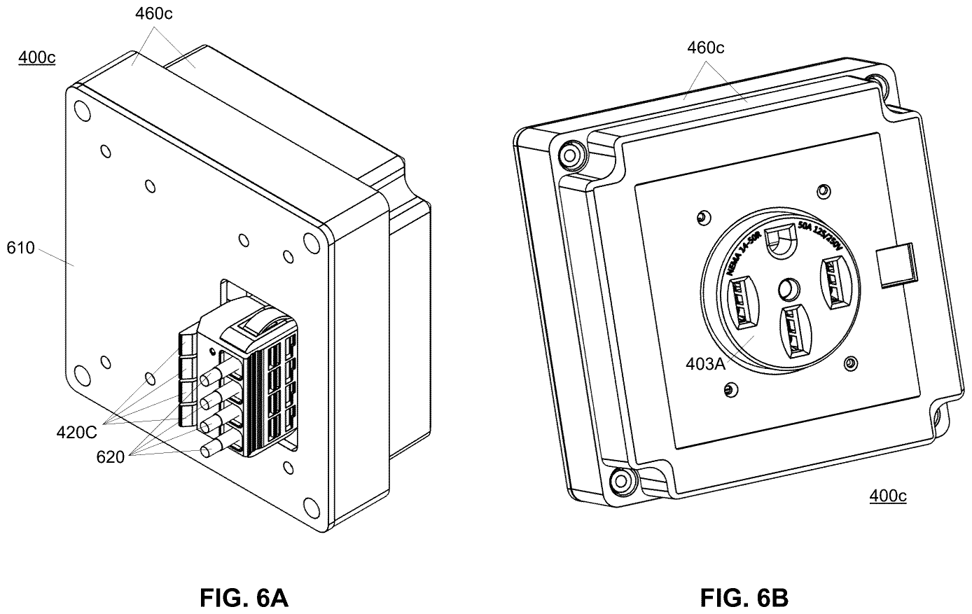

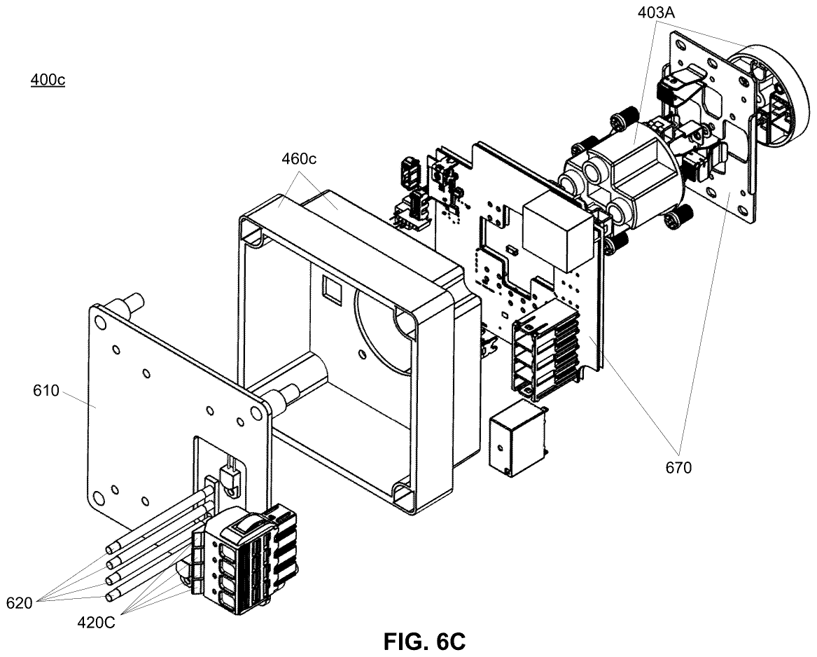

FIG. 4A shows an example apparatus and system for an electrical outlet with temperature monitoring and safety control. The apparatus is shown generally as apparatus 400a. While multiple examples of an apparatus are described herein, including apparatus 400a (described with respect to FIGS. 4A-4E), apparatus 400b (described with respect to FIGS. 4F-4N), and apparatus 400c (described with respect to FIGS. 6A-6C), reference herein to “apparatus 400” may refer to any one or more of apparatuses 400a, 400b, and/or 400c. The apparatus 400 may comprise an electrical outlet. The electrical outlet may comprise a receptacle 403A and a faceplate 403B, for example, either as a single unit or as separate/separable components. The receptacle 403A may correspond to the receptacle 103A described with respect to FIG. 3A, descriptions of which are incorporated by reference here. The faceplate 403B may correspond to the faceplate 103B described with respect to FIG. 3A, descriptions of which are incorporated by reference here. In at least some examples, the receptacle 403A may be configured to be a NEMA 14-50 compliant receptacle. In at least some other examples, the receptacle 403A may be compliant with one or more other standards and/or configurations (e.g., NEMA 5-50, NEMA 5-30, NEMA L5-30, NEMA TT-30, NEMA 5-20, NEMA L5-20, NEMA 5-15, NEMA L5-15, NEMA 6-15, NEMA L6-15, NEMA6-20, NEMA L6-20, NEMA 6-30, NEMA L6-30, NEMA 6-50, NEMA L6-50, NEMA 10-20, NEMA 10-30, NEMA 10-50, NEMA L14-20, NEMA 14-20, NEMA 14-30, NEMA L14-30, NEMA 14-60, NEMA 15-20, NEMA 15-30, NEMA 15-50, NEMA 15-60, and/or any other NEMA or non-NEMA configuration). In at least some examples, the receptacle 103A may be compliant with standards outside of NEMA jurisdiction such as the United States, Canada, and/or Mexico. For example, the receptacle 103A may be compliant with standards applicable to Europe (e.g., Europlug type C), Asia, Africa, Australia, and South America. For example, the receptacle 403A may be replaced with a 110-135 VAC receptacle, or any other type of receptacle. Additionally or alternatively, the receptacle 403A may be modified to include a plurality of receptacles of either similar or different types (e.g., a dual-receptacle outlet to accommodate a 220-277 VAC/NEMA 14-50 compliant receptacle and a 110-135 VAC/NEMA 5-15 or NEMA 5-20 receptacle). The receptacle 403A may be configured to operate for any voltage level/range, current level/range, and/or power level/range. The receptacle 403A may be configured with any quantity and/or type of terminals/connections to accept any type of plug (e.g., compatible with any standard/protocol/rating). In at least some examples, the apparatus 400 may be configured to be coupled to any number of receptacles of any type of receptacle.

While the apparatus 400 is shown in FIG. 4A with the receptacle 403A and the faceplate 403B, these components may be optional. For example, an apparatus and/or a system for temperature monitoring and safety control described herein may comprise features shown and described with respect to FIG. 4A excluding the receptacle 403A and/or excluding the faceplate 403B. In such an example, an apparatus and/or a system for temperature monitoring and safety control described herein may be configured to be compatible for coupling with one or more receptacles (e.g., an off-the-shelf receptacle) to provide temperature monitoring and/or safety control for that receptacle. Additionally or alternatively, one or more additional features (not shown) may be combined with one or more features shown and described with respect to FIG. 4A, such as an additional shroud, cover plate, and/or enclosure (e.g., covering in-part or in-full the components of the apparatus 400) and/or an electrical utility box that comprises one or more components of the apparatus 400.

When an electronic component, such as an EV charger, is electrically connected to the receptacle 403A, current flowing from wires, into the apparatus 400, and ultimately into terminals of the receptacle 403A may generate heat. This heat may cause terminals inside a receptacle to loosen. The receptacle 403A is configured to have its terminals coupled to a bus bar (addressed further herein with respect to bus bars 411-414). By coupling each terminal to a bus bar, the terminals of the receptacle 403A may be secured to one or more other components of the apparatus 400 in a manner that may maintain physically stable electrical connection(s) and/or that may reduce a likelihood of loosening terminals inside the receptacle 403A.

The apparatus 400 may comprise one or more of the following components that may be used to perform the temperature monitoring and safety control described herein: one or more bus bars 411, 412, 413, and 414 (shown in FIG. 4B); a printed circuit board (PCB) 410; a wire feed 420, an electrical switch 430 (e.g., a relay, a solid-state metal-oxide-semiconductor field-effect transistor, etc.), and a power converter 440. Each of these components is described further below.

FIGS. 4B, 4C, 4D, and 4E show different perspectives of the apparatus 400 described with respect to FIG. 4A, descriptions which are incorporated by reference with respect to each of these figures. FIG. 4B shows an example front-view of the apparatus 400. FIG. 4C shows an example back-view of the apparatus 400. FIG. 4D shows an example top-view of the apparatus 400. FIG. 4E shows an example side-view of the apparatus 400. Each component of the apparatus 400 may vary in size, shape, method of operation, and location than that shown and described, without departing from scope of the invention, such as shown and described with respect to FIGS. 4F-4N and FIGS. 6A-6C.

The wire feed 420 may receive one or more wires carrying an electrical supply. As shown, this wire feed 420 may be configured to receive a plurality of wires, such as two wires, three wires, or four wires. The four wires may correspond to the first electrical supply wire (e.g., L1), the second electrical supply wire (e.g., L2), ground, and (and optional) neutral described with respect to FIG. 3A and FIG. 3B. In at least some other examples, the wire feed 420 may receive any other quantity of wires different from the four shown (e.g., one, two, three, five, or up to any other quantity). For example, each wire may have an associated wire feed, or the wire feed 420 may be configured for other applications that may require fewer or a greater number of wire inputs.

The wire feed 420 may comprise one or more spring-loaded levers 420A (e.g., at least one spring-loaded lever per wire input), as shown in FIG. 4D. Additionally or alternatively, the wire feed 420 may comprise a clamp-type connection point for each of the one or more wires. Additionally or alternatively, the wire feed 420 may comprise one or more screws for (additional) securing of each of the wires. The wire feed 420 may enable an ease of installation, for example, by (primarily) securing the wires via insertion and pushing of a lever 420A for a respective wire (e.g., clamping the wire) without requiring screwing or soldering. Additionally, the wire feed 420 may provide advantages over other mechanisms for connection of electrical wiring (e.g., screw tightening, crimping, ferrules, soldering, etc.), such as by providing a reduced possibility of losing torque from a wall connection entering the apparatus 400. For example, and as described elsewhere herein, over the course of thermal cycles, fatigue may occur on one or more wires that may result in an upward force upon the wire(s). A clamping force of the spring-loaded lever(s) within the wire feed 420 may cause the wire(s) to be re-torqued in a downward manner. As a result, proper positioning of the wiring within the apparatus 400 may be maintained by the wire feed 420. Additionally, this clamping force of the spring-loaded lever(s) 420A within the wire feed 420 may help to maintain proper positioning of the wires within the apparatus without requiring periodic inspection and/or adjustment, which may lead to advantages such as improved performance and/or reduced maintenance cost.

In at least some examples, the wire feed 420 may comprise a cavity of any shape and/or any dimension (e.g., cylindrically-shaped, rectangular-prism shaped, etc.) that may be configured to provide an area that maintains open space surrounding each wire (e.g., relative to other wires and/or relative to other components of the apparatus 400). The cavity for each wire may provide open space around each wire that may yield improved airflow and/or overall reduced temperature around the area of the connection of the wire to the apparatus 400.

The wire feed 420 may be coupled to the PCB 410. The PCB 410 may be configured to electrically couple each wire from the wire feed 420 to one or more other components such as a power distributor and/or the power converter 440. While multiple examples of PCBs are described herein, including PCB 410 (described with respect to FIGS. 4A-4E) and PCB 410a and PCB 410b (described with respect to FIGS. 4F-4N), reference herein to “PCB 410” may refer to any one or more of PCBs 410, 410a, and/or 410b. A power distributor and/or the power converter 440 may be used to provide at least some power (e.g., converted to DC power) to one or more electronic components of the apparatus 400, such as a controller (e.g., a microcontroller), a switching driver, an electrical switch (e.g., the electrical switch 430), and/or a communication interface (e.g., a display, a wireless communication transmitter/transceiver, etc.). A power distributor may provide power (e.g., remaining power that may be in AC power) from the wire feed 420 to one or more electrical supply paths (e.g., corresponding to L1, L2, ground, or neutral), for example, via the PCB 410. The one or more electrical supply paths may be passed through a controllable switching device (e.g., configured to disconnect upon a thermal event detection, as described herein) that may be electrically coupled to a terminal of the receptacle 403A for providing power output from the receptacle 403A.

The PCB 410 may comprise one or more thermal sensors 415. A thermal sensor 415 may be coupled to a respective bus bar 411-414. For example, each of the two thermal sensors 415 shown in FIG. 4A may be coupled to one of the bus bar 412 or the bus bar 413. While not shown, two or more thermal sensors may be included such that each conductive path bus bar (e.g., two or more of bus bars 411-414) may have a respective thermal sensor 415 associated with it for performing thermal sensing for a particular bus bar. In such a manner, a thermal sensor 415 may be configured to thermally sense at a point closest to a potential failure due to heat experienced at the point(s) of connection between the respective input and/or output terminal of the receptacle 403A and the respective bus bar 411-414. While not shown in FIGS. 4A-4E, one or more of the bus bars 411-414 may be covered, such as by a non-conductive material, such as shown in the example of FIG. 4H with a cover 450. Additionally or alternatively, one or more thermal sensors may be configured to be located at any other position. For example, one or more thermal sensors may be located within the receptacle 403A to provide thermal sensing internal to the receptacle 403A. One or more thermal sensors may be directly connected to each bus bar (e.g., bus bars 411-414). One or more thermal sensors may be mounted to the PCB 410. One or more thermal sensors may be mounted to the apparatus 400 at a location different from a bus bar. One or more thermal sensors may be located within or near a wall and/or an enclosure in which the apparatus 400 may be installed. In at least some examples, safety control operations described herein relating to temperature monitoring/sensing (e.g., switching, disconnecting, and/or re-connecting of one or more electrical supply lines) may be based on thermal sensors located at more than one location and/or at more than one type of location. For example, a thermal measurement that exceeds a first threshold at a location of a bus bar and a thermal measurement that exceeds a second threshold at a second location (e.g., different from the location of a bus bar) may each cause triggering of a disconnection of an electrical supply line.

The bus bars 411-414 may be configured to electrically couple a respective input/terminal of the electrical receptacle 403A to one or more other components of the apparatus 400. The bus bars 411-414 may be made of a conductive material to enable current to flow to the electrical receptacle 403A. In at least some examples, the bus bars 411-414 may comprise a substantially flat surface and/or may comprise a sufficient surface area so as to perform a heat dissipation function (e.g., such as a heat sink) that may reduce a temperature around the respective bus bar 411-414. Additionally or alternatively, one or more heat sinks, fans, and/or other heat dispersion/reduction components may be included within the apparatus, for example, to reduce temperature within the apparatus 400 and/or within or near components of the apparatus 400. The bus bars 411-414 may be coupled to the PCB 410 via one or more securing mechanisms. For example, the bus bars 411-414 may be secured to the PCB 410 via a screw terminal, such as shown in FIGS. 4A-4E, and/or via any other type of securing mechanism. The bus bars 411-414 may comprise a bend to accommodate being electrically coupled to respective terminals of the receptacle 403A. As an example, the bus bars 411-414 may comprise an approximately ninety-degree bend to enable attachment on one end to the PCB 410 and on another end to a respective terminal of the receptacle 403A. The bus bars 411-414 may be secured to respective terminals of the receptacle 403A via threaded terminals and/or screws, and/or via any other securing mechanism.

The electrical switch 430 may comprise one or more relays, such as an off-the-shelf relay. In at least some examples, the electrical switch 430 may comprise a custom-designed relay. For example, the electrical switch 430 may be configured to operate switching for any quantity of electrical supply lines, at any current level(s)/range(s), at any voltage level(s)/range(s), and/or at any power level(s)/range(s). In at least some examples, the electrical switch 430 may comprise a solid-state relay (e.g., comprising one or more metal-oxide-semiconductor field-effect transistors (MOSFETs)). For example, while shown in FIG. 4A as the outermost-extended component coupled to the PCB 410, the electrical switch 430 may comprise any size/shape and may be substantially smaller than shown (e.g., MOSFET(s) may cover a substantially smaller surface area than the electrical switch 430 shown in FIG. 4A). In at least some examples, the electrical switch 430 may comprise a solid-state switching mechanism comprising at least one of: a metal-oxide semiconductor field effect transistor or a Gallium Nitride (GaN) FET, either of which may be capable to provide sufficient power density in a sufficiently small package. A MOSFET is a type of transistor that operates as a voltage-controlled switch and/or amplifier for electrical signals. Accordingly, one or more MOSFETs may be used as the electrical switch 430 for switching power and/or amplifying signals. In at least some examples, the electrical switch 430 may be configured for operating at voltage levels up to 340 VAC (or other voltage level) and/or for operating with up to 65A of current (or other current level). The electrical switch may be configured to perform a switching operation quickly, such as at speeds of 1 ms, less than 1 ms, or any other duration.

As another example, such as shown in FIG. 4H, the electrical switch 430 may comprise a plurality of relays, such as relay 430a and relay 430b, or any number of relays or other switching components. Reference herein to the electrical switch 430 may correspond to any of electrical switch 430, relay 430a, and/or relay 430b. The electrical switch 430 may comprise one or more fuses and/or circuit breakers. In at least some examples, the electrical switch 430 may comprise a plurality of switching mechanisms, each of which may be configured to disconnect at least one electrical supply line, for example, based on a different condition. For example, one or more switching elements may be configured to disconnect at a first threshold level of temperature that is measured and one or more other elements (e.g., fuse and/or circuit breaker) may be configured to disconnect at a second threshold level of temperature that is measured, so as to provide potentially more robust safety control. The electrical switch 430 may comprise a 50 Amp relay, or any other current rating corresponding to an electrical panel circuit breaker current rating (e.g., accounting for de-rating). The electrical switch 430 may be rated for a voltage greater than the operating level of the electrical supply voltage (e.g., greater than 110-135 VAC and/or 220-277 VAC, such as 500 Volts). The electrical switch 430 may comprise a plurality of legs, for example, to switch a plurality of electrical supply lines at substantially the same time. In at least some examples, a relay/contactor may disconnect multiple voltage supplies in parallel or in a series configuration. For example, a multiple leg/phase contactor may be used to connect or disconnect a single voltage supply line redundantly for increased safety applications (e.g., a single voltage supply line may be connected to a first phase/leg, then from the output of the first leg/phase to the input of another phase/leg, and the output of that phase leg may be connected to an application). In at least some examples, a relay/contactor may comprise one or more legs (e.g., at least three legs in some examples) that may enable disconnection of each of a first electrical supply (e.g., L1), a second electrical supply (e.g., L2), and a neutral line at substantially the same time, based on a thermal event detection at any one or more of the respective three lines (e.g., L1, L2, neutral). In at least some examples, the relay or contactor may comprise fewer than three legs or more than three legs, for example, depending upon how many lines should be disconnected upon a detected thermal event.

While not shown, the apparatus 400 may comprise one or more interfaces. For example, the apparatus 400 may comprise a user interface. The user interface may provide information such as operation status, failure indication(s), thermal measurement(s), current level(s) and/or average current and/or peak current level(s) over a time duration (e.g., a charging cycle), voltage level(s) and/or average voltage and/or peak voltage level(s) over a time duration (e.g., a charging cycle), power level(s) and/or average power and/or peak power level(s) over a time duration (e.g., a charging cycle), cost information associated with power usage, time of a current cycle, expected time and/or duration for completion of a current cycle, and/or any other information. The user interface may be configured to operate with any wired and/or wireless communication protocol, such as WiFi (e.g., IEEE 802.11(g)), cellular (e.g., 3GPP 3G, LTE, 5G, 6G, etc.), Bluetooth (e.g., Bluetooth Low Energy (BLE)), and/or any other communication standard/version/protocol. The user interface may be configured to communicate with any type of device, such as but not limited to, a cellular phone/smartphone, a tablet, a computer, an Internet-of-Things (IoT) device, a home integration device (e.g., Alexa), an electrical panel (and/or an electronic component configured to communicate with an electrical panel), an EV charger, a vehicle (e.g., EV, plug-in hybrid, recreational vehicle), a smart device, and/or home and/or electrical services (e.g., security and/or monitoring systems, a utility company, etc.). The user interface may comprise one or more buttons, control inputs, and/or touch screens. The control interface may be configured to control one or more operations of the apparatus, including but not limited to, thermal sensing (e.g., temperature settings, limits, thresholds, etc.), switching (e.g., relay operation for one or more electrical supply lines), and/or any operational setting (e.g., power on/off time(s) and/or durations).

In at least some examples, the one or more interfaces may be configured to operate in a wireless energy management system (EMS). An EMS may use wireless communications to monitor and/or control energy consumption (e.g., in buildings or homes), which may help to optimize efficiency and/or reduce energy cost. The EMS may comprise one or more sensors, smart meters, and/or a central control hub (and/or application/App) to gather data, analyze usage patterns, and/or automate control of devices such as smart plugs and switches. Accordingly, the apparatus 400 may be configured to operate in an EMS such that the apparatus 400 may be wirelessly controlled by, and/or may wirelessly report to, one or more other devices in the EMS.

In at least some examples, the apparatus 400 may comprise power metering. For example, the apparatus 400 may comprise an outlet (such as a 240V outlet) configured with integrated, utility-compliant power metering. For example, the receptacle 403A may comprise a built-in meter that may be certified for billing (e.g., commercial billing, residential billing, etc.). The receptacle 403 may be configured (primarily) for Level 2 EV charging, whereby customers may be charged based on energy their connected EV receives in an EV charging procedure. A system for power metering may comprise, for example, a power delivery system, an energy metering system, a control and/or communication system, and/or a transaction management system. The power delivery system may be an essential function to transfer high-power AC electricity from an AC power circuit capable of operating at a sufficient voltage level for EV charging, such as Level 2 EV charging (e.g., 208/240V). The energy management system may comprise an integrated, revenue-grade power meter configured to (accurately) measure electrical energy (e.g., in kWh) transferred to an EV. The power meter may be configured to be tamper-resistant, for example, to help ensure integrity of billing data. The control and/or communication system may comprise at least one of a processor and/or a network interface (e.g., cellular modem, WiFi, Bluetooth, BLE, Zigbee, etc.). The control and/or communication system may be configured to create a link between the apparatus 400 and a remote server to enable remote monitoring, control commands (e.g., start/stop charging), and/or dynamic power adjustment for load management. The transaction management system may comprise a user authentication interface (e.g., RFID reader, module for mobile app communication, etc.) and/or a payment processing module. The transaction management system may be configured to identify a user, authorize a charging session, and/or calculate a financial charge based (directly) on the energy data provided by the energy metering system.

In at least some examples, the apparatus 400 may comprise an enhanced smart outlet. For example, the apparatus 400 may be configured to operate in an intelligent electrical outlet system that may incorporate an on-board module, such as an on-board artificial intelligence (AI) module, to provide autonomous control and/or predictive safety monitoring. For example, the apparatus 400 may comprise a smart electrical outlet that may be equipped with an embedded AI and machine learning (ML) core. This AI core may enable the apparatus 400 to understand and/or process voice commands for direct control and/or complex configuration. The apparatus 400 may integrate one or more sensors, such as current, voltage, and/or temperature sensors. Data from the one or more sensors may be (continuously) analyzed by the AI to perform operations such as detect anomalies, predict failures, and/or optimize power usage. The apparatus 400 may be configured through natural language to execute specific actions in response to triggering events. For example, a user may be able to instruct the apparatus 400 to operate according to the following instruction/command: “If the temperature goes above 140 degrees Fahrenheit, shut off the power and send a notification to my phone.” The AI core may be configured to autonomously manage one or more events, such as: identifying a conclusion of an EV charging cycle by detecting a sharp drop in current, and/or identifying a hazardous extended high-current condition from a faulty appliance and, in response, preemptively disable power. The apparatus 400 may be configured with advanced wireless communication capabilities to seamlessly integrate with other smart devices. For example, the apparatus 400 may be configured to: communicate with smart circuit breakers to report fault conditions; interact with smart home ecosystems such as Amazon Alexa, Apple HomeKit, and Google Home; and/or establish direct communication with one or more appliances (such as an EV) to manage charging sessions intelligently.

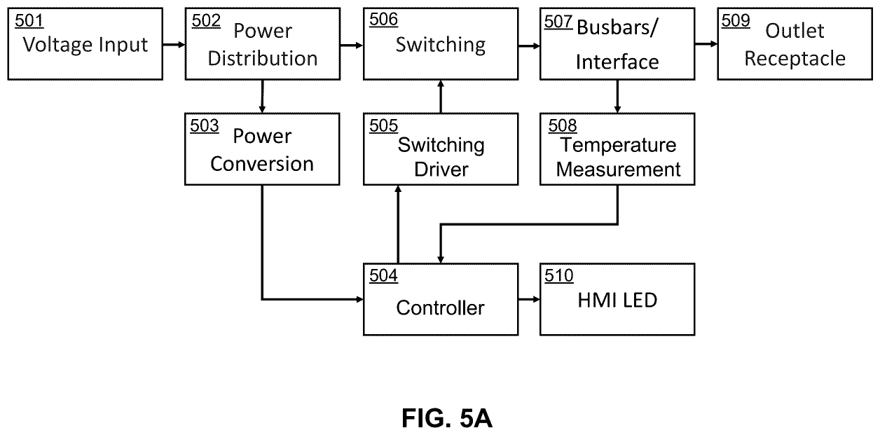

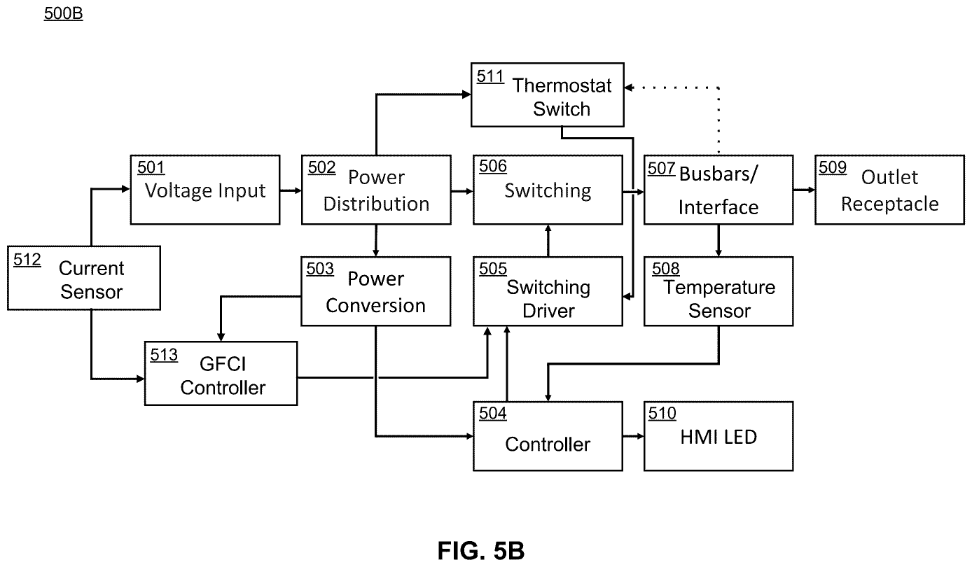

In at least some examples, the apparatus 400 may comprise a splitter (not shown). A splitter may comprise a 240V outlet splitter that may be configured to enable sharing of a single high-power output between two devices, such as a clothes dryer, an EV charger, and/or any appliance or other device. The splitter may comprise a smart splitter for automatic power switching, which may help to prevent circuit overloads such as by helping to ensure that only one device draws significant power at a time. The splitter may intelligently prioritize one or more particular devices (e.g., a particular appliance), and after a device finishes its cycle, power may be automatically directed to another device. This prioritization operation may provide a convenient way to access faster Level 2 EV charging, for example, without the time/expense of installing a new dedicated circuit. Installation of a splitter may involve a simple plug-and-play process with no wiring required. Splitters may be UL and/or ETL certified for safety and/or may comprise NEMA plug configurations to fit common device/appliance (e.g., dryer or range) outlets. The splitter may provide advantages such as improved safety, greater convenience, and/or cost-effectiveness in providing a solution for managing high-power needs, such as in a modern home or office. In at least some examples, the apparatus 400 may comprise a splitter such that the apparatus 400 (or components thereof) may be configured to detect an overheating condition at a connection point within the splitter; and at least one switch in a switching module (e.g., 506 described with respect to FIGS. 5A and 5B) may be configured to interrupt the flow of electrical power to at least one of the 240V output receptacles or to the entire splitter system based on a detection of the overheating condition. In at least some examples, monitoring of two or more terminals may be performed with an ability to independently enable and/or disable power. In at least some examples, a system described herein may provide an ability to monitor a temperature at a receptacle and/or to disable power to (one or) both outputs upon overheating. In at least some examples, a system described herein may provide an ability to apply user definable load management strategies (e.g., prioritization, sequential switching, dynamic throttling) and/or specific NEMA configurations of input/output receptacles (e.g., NEMA 14-50R for all outputs).

In at least some examples, the apparatus 400 may be configured to be pre-wired. For example, the apparatus 400 may comprise a NEMA-approved enclosure (e.g., such as 460b in FIG. 4N and/or 460c in FIGS. 6A-6C) that may be dimensionally similar to any certified electrical enclosure (e.g., a standard 2-gang box, a 2 to 4-gang box, an external wall mount device, a conduit box, a junction box, a receptacle assembly, etc.). The enclosure may be configured to be a NEMA 14-50R receptacle that may be factory-installed and/or pre-wired. For example, the apparatus 400 (such as apparatus 400c) may comprise an integrated junction compartment, separate from a main receptacle housing, where factory-installed internal wiring may be terminated. Using such an apparatus 400, an electrician in the field may need only to mount the apparatus, bring a branch circuit cable into a junction compartment of the apparatus 400, and connect field conductors to pre-installed connectors (e.g., pigtails, a terminal block, or push-in connectors) of the apparatus 400.

While the apparatus 400 is shown (e.g., in FIG. 4A) with a receptacle 403A configured to receive a 4-prong power cable, in at least some examples the receptacle 403A may be configured with fewer prongs or as a prongless outlet. For example, instead of using prongs and slots, a prongless outlet may utilize a flush-mounted, magnetic conductive interface. Such an outlet may comprise a flat, smooth surface that remains completely de-energized until a matching magnetic plug from an appliance is placed onto it. Powerful magnets in the plug and outlet may be configured to automatically align the connection and securely hold it in place, at which point a circuit may be activated and power may to flow into the receptacle 403A. When the plug is removed, power to the outlet surface may be instantly cut off Such a prongless design may virtually eliminate a risk of electrical shock from inserting foreign objects, which may provide enhanced safety (e.g., for homes with children or for use in areas like garages and workshops). In particular, for high-power 240V applications, prongless receptacle technology may provide a sleek, modern, and/or intrinsically safe alternative to conventional outlets, which may be particularly desirable for applications such as EV chargers, dryers, and/or other large appliances. In at least some examples, an apparatus 400 as described herein may comprise: a controller (e.g., 504 in FIGS. 5A and 5B) that may be configured to receive temperature data from a thermal monitoring system and determine when/whether a detected temperature exceeds a predetermined safe threshold; and an electrical switching module (e.g., 506 in FIGS. 5A and 5B) that may be electrically coupled to the controller (504) and that may be configured to automatically interrupt a flow of electrical power through an electrical interface based on (e.g., in response to) the controller (e.g., 504) detecting a predetermined safe threshold being (reached or) exceeded, thereby preventing thermal hazards in a prongless electrical connection.

The apparatus 400 shown in FIGS. 4A-4E may comprise any size and/or shape. One or more components shown in these figures may be excluded from the apparatus 400. The apparatus 400 may comprise one or more additional components not shown in these figures, including any components/operations described herein.

FIG. 4F shows an example apparatus and system for an electrical outlet with temperature monitoring and safety control, which may include any of the features described with respect to FIG. 4A. FIGS. 4G, 4H, 4I, and 4J show different perspectives of the apparatus 400b described with respect to FIG. 4F, descriptions which are incorporated by reference with respect to each of these figures. FIG. 4G shows an example front-view of the apparatus 400b. FIG. 4H shows an example back-view of the apparatus 400b. FIG. 4I shows an example top-view of the apparatus 400b. FIG. 4J shows an example side-view of the apparatus 400b. Each component of the apparatus 400b may vary in size, shape, method of operation, and location than that shown and described, without departing from scope of the invention, such as shown and described with respect to FIGS. 4A-4E.

As shown in FIG. 4F, the PCB 410 may comprise a plurality of PCBs, such as shown as PCB 410a and PCB 410b. In at least some examples, a first PCB (e.g., PCB 410a) may comprise one or more (or all) features described with respect to the PCB 410, and a second PCB (e.g., PCB 410b) may comprise one or more other features, such as one or more interfaces and/or communication modules (e.g., wireless communication device such as a transceiver, receiver, or transmitter) for functions such as external control and/or reporting.

FIG. 4K shows additional details of the apparatus 400b shown in FIG. 4G and FIG. 4H. As shown, the apparatus may comprise a receptacle (1), such as a NEMA 14-50 receptacle, and one or more PCBs, such as the PCB 410a and/or the PCB 410b. The PCB 410a may comprise one or more features such as a development board and/or an interface for a development board (2) (such as an ESP32-C3 mini development board or any other type of development board) for operations such as wireless communications (e.g., Wi-Fi, Bluetooth, Bluetooth Low Energy, Zigbee, cellular LTE/5G/6G, etc.), a reset button (3), and/or a one or more ports such as a programming port (4) and/or SD card module (5). The PCB 410b may comprise one or more features related to the temperature monitoring and safety control described herein, such as a power converter (6) (e.g., 240 VAC/12 VDC power converter), L1 terminal block (7), L2 terminal block (8), (optional) neutral terminal block (9), and ground terminal block (10). The PCB 410b may further comprise one or more power relays (11) and/or one or more touch guards (12). In at least some examples, wireless communications may provide: monitoring and/or control of energy consumption by the apparatus 400; operational data such as energy consumption, weekly usage reports, thermal trending data; and/or control functions such as remote enable/disable, scheduling of power delivery, and the like. In at least some examples, the apparatus 400 may comprise a transceiver (e.g., that may be integrated with the controller 504 described with respect to FIGS. 5A and 5B) that may be configured to: transmit operational data from the electrical receptacle, such as real-time temperature measurement(s) and/or historical thermal trend(s), to a remote energy management system and/or user application; and/or receive one or more control signals from a remote energy management system and/or user application, such as to manage and/or adjust power delivery through the electrical receptacle 400.

While not shown in FIGS. 4A-4K, the apparatus 400 may be additionally configured with, or adapted for, any other safety mechanism. For example, the apparatus 400 may be configured with, or adapted for being coupled to, one or more safety-related interfaces such as a GFCI interface. A GFCI interface may be coupled to a GFCI controller, such as described with respect to 513 in FIG. 5B. Such a configuration may provide an apparatus 400 with the temperature monitoring and safety mechanisms described herein in combination with added safety of a GFCI, such as for enhanced safety with outdoor use or other use that may have potential for exposure to water. The apparatus 400 may be packaged with a GFCI included. In at least some examples, the apparatus 400 may be adapted with an interface for coupling with an external GFCI apparatus. A GFCI may provide additional safety by detecting and interrupting potentially dangerous ground faults, which are unintended paths for electrical current to flow to the ground. The GFCI may operate by (constantly) monitoring a current flowing through hot and neutral wires of an electrical circuit. If there is a difference in current, indicating that some electricity is flowing elsewhere (like through a person's body to the ground), the GFCI is configured to quickly trip, cutting off the power and preventing a potentially harmful electrical shock. As an example, the apparatus 400 may be configured with a current sensor and a GFCI, wherein the GFCI may be configured to receive an indication of a current measurement from the current sensor, and cause at least one switch to interrupt a flow of electrical power from a 220 to 277 VAC input power to an electrical receptacle. The GFCI threshold may be preconfigured to cause such an electrical disconnect based on a detected/sensed current threshold such as 6 mA, 30 mA or any other amount of current. The GFCI may be an integrated component within the receptacle 400. In at least some examples, the GFCI may be configured to be disabled, and/or re-enabled, such as by one or more mechanical switches and/or buttons.

FIG. 4L shows additional details of a portion of the apparatus 400b shown in FIGS. 4F-4J. For example, two sides of the PCB 410a are respectively shown at the left and at the right of FIG. 4L. Additionally, labels 501, 503, 506, 507, and 511 are shown indicating optional placement on the PCB 410a of one or more components that may be used to perform the same-numbered features described herein with reference to FIG. 5A and/or FIG. 5B.

FIG. 4M shows additional details of a portion of the apparatus 400b shown in FIGS. 4F-4J. For example, two sides of the PCB 410b are respectively shown at the left and at the right of FIG. 4L. Additionally, labels 501, 503, 504, 505, 506, 507, and 508 are shown indicating optional placement on the PCB 410a of one or more components that may be used to perform the same-numbered features described herein with reference to FIG. 5A and/or FIG. 5B.

FIG. 4N shows additional example details of the apparatus and system of FIG. 4F within an enclosure. As shown, the apparatus 400b may comprise an enclosure 460b. The enclosure 460b may comprise any type of electrical enclosure such as described further herein. The lower-right portion of FIG. 4N shows a front-facing view of the apparatus 400b within the enclosure 460b and with the receptacle 403A outward facing and mounted through a faceplate 403C. The top portion of FIG. 4N shows an exploded view of the apparatus 400b. The apparatus 400b may comprise one or more layers 470 upon which one or more components described herein may be mounted. As examples, the one or more layers 470 may comprise one or more PCBs (e.g., 410 shown in FIGS. 4A-4E, and/or 410a and/or 410b shown in FIGS. 4F-4M) and/or one or more faceplates (e.g., 403B shown in FIGS. 4A-4E, and/or 403C shown in FIG. 4N). The receptacle 403A may comprise a plurality of portions such as shown in the exploded view of FIG. 4N.

FIG. 5A shows an example system and method for temperature monitoring and safety control for an electrical outlet. While reference to steps are provided as examples, each of the numerically identified operations described with respect to FIG. 5A may correspond to one or more components that are configured to perform described operation, and thus, a step and a component for performing that step may be referred to herein by the same numeral. One or more operations of a system and/or method 500A shown and described with respect to FIG. 5A may be performed by one or more components of the apparatus 400 described with respect to FIGS. 4A-4N and/or FIGS. 6A-6C.

The system and/or method 500A may comprise a voltage input interface for receiving a voltage input at step 501. The voltage input 501 may comprise any voltage level, such as 110-135 VAC, 220-277 VAC, or any other voltage level or range of voltage levels. In at least some examples, the voltage input 501 may comprise a first electric supply (e.g., described herein as L1), a second electric supply (e.g., described herein as L2), a ground, and a neutral. The voltage input 501 may be received by a wire feed, such as the wire feed 420. One or more operations of the wire feed 420 described herein may be performed at step 501.

At step 502, the voltage input 501 may be provided for performing power distribution. The power distribution 502 may be performed by one or more components on a PCB such as PCB 410. In at least some examples, one or more operations of a power distributor described herein may be performed at step 502. At step 502, received input voltage may be split into a plurality of outputs, including at least one output for power conversion (e.g., to supply power to one or more electronic components of the apparatus 400) and at least one output for supplying power to a receptacle (e.g., receptacle 403A).

At step 503, power conversion may be performed. Power may be provided as an input voltage and input current (e.g., by or within a power distribution from step 502). The input voltage may be converted to a different voltage level and/or a different voltage type. As an example, the input voltage may be a 110-135 VAC electric supply or a 220-277 VAC electric supply, which may be converted by the power conversion into a 2 to 24 Volt DC voltage (e.g., 5 Volts, 10 Volts, etc.) that may be used to power one or more electronic components (e.g., electronic component(s) on the PCB 410). The power conversion 503 may be performed by a power converter, such as the power converter 440, and/or by one or more (additional or different) components, such as a transformer, one or more diodes (e.g., full wave rectifier), voltage regulator(s), capacitor(s), resistor(s), and/or any other electronic component(s). One or more operations of the power converter 440 described herein may be performed at step 503.

At step 504, one or more controller operations may be performed. For example, a controller 504 such as a microcontroller may receive a power supply (e.g., output from the power conversion step 503) to perform one or more controller operations. The controller 504 may be mounted onto the PCB 410. The controller 504 may receive an input in the form of one or more thermal indications (e.g., from a temperature measurement step 508 described herein). The one or more thermal indications may comprise a digital signal, an analog signal, and/or one or more voltage level indicators, described further with respect to step 508. For example, the one or more thermal indications may comprise one or more signals, such as a high or low voltage signal in the case of a thermal switch being used. Additionally or alternatively, the one or more signals may comprise one or more converted analog-to-digital signals that may be communicated to a controller (e.g., at step 504), to a microcontroller, via a two-wire serial communication protocol such as a half-duplex communication or an inter-integrated circuit (e.g., i2c) or a full-duplex communication or serial peripheral interface (e.g., SPI), and/or via a board communication (e.g., if performed by a digital sensor). Based on the one or more thermal indications, the controller 504 may output one or more control signals to control one or more electrical paths (e.g., L1, L2, ground, neutral) as step 505. In at least some examples, the one or more controller operations at step 504 may not be performed, or may not be performed by a controller. For example, switching at step 506 may be performed based on signal (e.g., an analog voltage signal) from one or more temperature measurement devices (e.g., from step 508) that may be provided via a switching driver (e.g., at step 505) without using a controller. In at least some examples, one or more controller operations may provide communications and/or information (e.g., status, measurements, etc.) without controlling a switching driver and/or without controlling a switching operation.

As step 505, a switching driver may receive the control signal(s) output by one or more controllers at step 504 and/or from temperature measurement devices (e.g., from step 508). Based on the control signal(s) and/or temperature measurement output(s), the switching driver 505 may control one or more switching operations, described with respect to step 506. The switching driver 505 may be performed within an electrical switch, such as the electrical switch 430, and/or by one or more (additional or different) components. One or more operations of the electrical switch 430 described herein may be performed at step 505. To control one or more switching operations, the switching driver 505 may actuate a coil on a switch such as a relay (and/or actuate one or more MOSFET or other solid-state component(s)) to ensure an appropriate voltage at a point of switching (e.g., at step 506) based on one or more control signals (e.g., output at step 504).

At step 506, a switching operation may be performed. The switching operation 506 may comprise receiving at least one output from step 502 for supplying power. In at least some examples (such as for a 220-277 VAC electrical supply), the power supplied to and from the switching operation 506 may comprise a first electric supply (e.g., described herein as L1), a second electric supply (e.g., described herein as L2), a ground, and a neutral. The switching operation 506 may be controlled by a switching driver (e.g., at step 505) that may be controlled based on one or more temperature measurements (e.g., at step 508 described herein) and/or based on one or more controllers (e.g., at step 504). As an example, if a temperature measurement associated with at least one electrical supply path (e.g., L1, L2, ground, neutral) exceeds a threshold, the switching operation 506 may be configured to disconnect all power (e.g., disconnect L1, L2, ground, and neutral) to the receptacle 403A. In at least some other configurations, if a temperature measurement associated with at least one electrical supply path (e.g., L1, L2, ground, neutral) exceeds a threshold, the switching operation may be configured to disconnect the corresponding electrical supply path (e.g., between the power distribution and the respective bus bar 411/412/413/414 for the corresponding electrical supply path). Switching may be performed by an electrical switch such as a relay (e.g., the electrical switch 430).

The switching operation at step 506 may be (additionally) controlled by one or more timers and/or by one or more user controls. For example, after a disconnection due to a temperature measurement exceeding a threshold, one or more electrical supply paths may be re-connected. The re-connection may be performed based on an expiration of a timer (e.g., initiated/started at or around a time of the disconnection), based on a subsequent temperature measurement that is below and/or that satisfies a threshold level, and/or based on an operation performed by a user (e.g., engagement of a switch, use of a software application and/or a smartphone App, and/or any other wired or wireless user interface controller). In at least some examples, the switching operation 506 may comprise a fuse, a circuit breaker, and/or a relay. One or more operations of the electrical switch 430 described herein may be performed at step 506.

At step 507, an output (if any) of the switching operation may be provided as an input to one or more bus bars. One or more operations of the bus bars 411-414 described herein may be performed at step 507. For example, if a temperature threshold has not been exceeded on any electrical supply line (e.g., based on one or more measurements at step 508 described herein), one or more bus bars may receive an electrical supply and pass that electrical supply on to one or more terminals of a receptacle (e.g., the receptacle 403A). If, however, a temperature threshold has been exceeded on one or more electrical supply lines (e.g., based on one or more measurements at step 508 described herein), all power to the receptacle 403A may be disconnected, or the (respective) bus bar(s) for the one or more electrical supply line(s) may no longer receive power (e.g., based on a disconnection by the switching operation at step 506). In at least some examples, four bus bars may be provided (e.g., bus bars 411-414), with one bus bar for each of a first electrical supply (e.g., L1), a second electrical supply (e.g., L2), a ground, and a neutral. In at least some other examples, greater or fewer bus bars may be provided. For example, a first bus bar may be provided for a first electrical supply path (e.g., L1) and a second bus bar may be provided for a second electrical supply path (e.g., 2) that may generally conduct a higher level of current than other paths such as neutral and ground, and the neutral and ground paths may not include a bus bar. As another example, three bus bars may be included for each of L1, L2, and neutral. As yet another example, two or three bus bars may be included, such as for a NEMA 6-50 receptacle, in which a first bus bar may be provided for a first electrical supply path (e.g., L1), a second bus bar may be provided for a second electrical supply path (e.g., L2), and (optionally) a third bus bar may be provided for a ground path, but there may be no neutral path such that an additional bus bar may not be included. As still another example, one or two bus bars may be included, such as for a NEMA 5-15 receptacle, in which a first bus bar may be provided for a first electrical supply path (e.g., L1) and (optionally) a second bus bar may be provided for a ground path, but there may be no neutral path such that an additional bus bar may not be included. In at least some other examples, a greater number of bus bars may be provided, for example, to accommodate a greater number of terminals in a receptacle and/or to accommodate more than one electrical receptacle.

At step 508, temperature measurement may be performed. Temperature measurement 508 may comprise thermal monitoring/measuring of one or more electrical supply lines. For example, one or more thermal sensors may be coupled to (or nearby) one or more bus bars (e.g., bus bars 411-414). The one or more thermal sensors may correspond to the thermal sensors 415 described with respect to FIGS. 4A-4E, such that one or more operations of the thermal sensors 415 described herein may be performed at step 508. In at least some examples, one or more thermal sensors may be mounted onto each bus bar configured to carry an electrical supply. The one or more thermal sensors may measure heat/temperature at or near a respective bus bar. The thermal sensor(s) may output one or more signals to control one or more operations based on the measured heat/temperature. For example, the temperature measurement at step 508 may provide one or more output signals that may be provided to: a switching driver (e.g., at step 505), one or more switching operations (e.g., at step 506), and/or one or more controllers for one or more controller operations (e.g., at step 504). The one or more controller operations may disconnect an electrical supply otherwise configured to pass through a bus bar that experienced a measured heat/temperature (by one or more thermal sensors) exceeding a threshold level, for example, in order to prevent further exposure to potentially dangerous/damaging heat.

Temperature measurement herein may comprise one or more types of temperature measurement. For example, temperature measurement may comprise one or more of a resistance measurement, a thermocouple, and/or a positive-temperature-coefficient (PTC). In at least some examples, an estimate of a temperature level may be determined, for example, based on one or more detected variations of a power level (e.g., detection of surges or micro-surges) that may be indicative of arcing and/or micro-arcing that may correspond to a temperature increase. Such an estimate of a temperature level may be reported at step 508 as an indication of a thermal event for potentially triggering a switching operation (e.g., at step 506) and/or at step 504 for controlling a switching operation (e.g., at step 506).

At step 509, power may be provided (e.g., from the bus bar(s)) to an outlet receptacle. The outlet receptacle may correspond to the receptacle 403A. The power may be provided in the form of a first electrical supply (e.g., L1), a second electrical supply (e.g., L2), a ground, and a neutral. In at least some examples, the receptacle may be NEMA 14-50 compliant and/or the power provided by the receptacle may be a voltage level of 220-277 VAC or any other voltage level.

At step 510, a control interface, such as a human machine interface (HMI) light emitting diode (LED) display, may provide one or more outputs (e.g., visual outputs, data outputs, signals, etc.) and/or may receive one or more user inputs. For example, the apparatus 400 may comprise a display indicating one or more statuses of one or more electrical supply lines. The display may comprise one or more LEDs (e.g., green=operational/no faults; red=fault/failure/high temperature detected; off=no electricity detected), liquid crystal displays (LCDs), graphics, numerical and/or text data, and/or any other indicator(s). The display may be user-touch controlled, button-controlled, and/or controlled via any wired and/or wireless communications (e.g., WiFi-enabled, Bluetooth-enabled, cellular-enabled, etc.).

FIG. 5B shows an example system and/or method for temperature monitoring and safety control for an electrical outlet. While reference to steps are provided as examples, each of the numerically identified operations described with respect to FIG. 5B may correspond to one or more components that are configured to perform described operation, and thus, a step and a component for performing that step may be referred to herein by the same numeral. One or more operations of a system and/or method 500B shown and described with respect to FIG. 5B may be performed by one or more components of the apparatus 400 described with respect to FIGS. 4A-4N and/or FIGS. 6A-6C. Additionally or alternatively, one or more operations of the system and/or method 500B may correspond to similarly numbered operations of the method 500A, incorporated by reference here.

The system and/or method 500B may comprise a thermostat switch operation at step 511. The thermostat switch 511 may be configured to control a switching driver at step 505 (e.g., instead of or in addition to control via a controller at step 504). The thermostat switch 511 may receive power from the power distribution 502. The thermostat switch 511 may measure/absorb heat from the busbars/interface 507, such as shown in the dashed input line to the thermostat switch 511. The thermostat switch operation 511 may be performed by a thermal sensor. For example, a thermal sensor may be configured such that, as soon as a temperature at or above a threshold is sensed (e.g., 60 degrees Celsius, 70 degrees Celsius, 80 degrees Celsius, or any other predetermined temperature level), a switch may be opened which may trigger the switching driver 505 to control a relay at the switching step 506.

In at least some examples, the thermostat switch operation 511 may be performed by an electronic or electromechanical switching component that may be configured to respond to one or more thermal conditions. A thermal switch may be used that may comprise one or more input interfaces configured to receive temperature data and/or may comprise one or more output interfaces configured to control power distribution within an apparatus configured to perform the method 500B, such as an electrical receptacle system described herein. The thermostat switch operation 511 may be implemented as a solid-state switch, such as a metal-oxide-semiconductor field-effect transistor (MOSFET) or a relay mechanism. In at least some examples, a thermostat switch 511 may be integrated within a physical structure of an electrical outlet, which may enable thermal monitoring directly at the receptacle level.

At least one function of a thermostat switch that may be configured to perform step 511 (e.g., a primary function) may be to provide automatic power cutoff at a source if, for example, overheating is detected within an electrical receptacle. Such a switch may act as a critical safety mechanism that may proactively help to prevent an electrical fire that may otherwise be caused by excessive heat buildup at a connection point between a building's fixed wiring and a receptacle's terminals. Upon receiving a signal from the temperature sensor (e.g., at 508) indicating that a predefined thermal threshold has been satisfied (e.g., reached or exceeded), a thermostat switch (e.g., at 511) may be configured to disrupt an electrical power path to mitigate a risk of thermal runaway and associated hazards.

In at least some examples, a thermostat switch (e.g., 511) may be coupled (e.g., thermally coupled) to the busbars/interface (e.g., at 507). In such a manner, the thermostat switch may be configured to sense/detect heat from within a receptacle. Based on this thermal sensing/detection, the thermostat switch may control a power distribution (e.g., 502), such as by directly interrupting the electrical connection to the busbars/interface (e.g., 507) and/or by signaling a switching block (e.g., 506 via 505 switching driver) to open a circuit. This interaction may help to ensure that power is disconnected timely (e.g., immediately) upon detection of an overheating event, which may help to prioritize safety of an electrical system and its surroundings. For example, by being thermally coupled to the busbars/interface (e.g., 507), the thermostat switch (e.g., 511) may be configured to directly communicate to the switching driver (e.g., 505) to trigger rapid/immediate disconnection if an overheating event is detected.

The system and/or method 500B may comprise a current sensor 512. The current sensor 512 may comprise an electrical transducer and/or a sensing element configured to measure a magnitude and/or characteristics of electrical current flowing through the system/method 500B. The current sensor 512 may be positioned in a primary current path, such as after the voltage input (e.g., 501), to monitor a current draw of a connected load. The current sensor 512 may be configured to detect one or both of normal operational currents and abnormal current conditions, such as those indicative of ground faults. In at least some examples, a primary function of the current sensor 512 may be to continuously monitor a flow of electrical charge (current) within the electrical circuit of the system/method 500B. This monitoring may be crucial for various safety and operational functions, such as detecting imbalances in current flow between hot and neutral wires that signify a ground fault.

In at least some examples, the current sensor 512 may provide its current measurements directly to a GFCI Controller 513. Real-time current data may be essential for the GFCI Controller 513 to perform ground fault detection logic. The current sensor 512 may act as an input mechanism for ground fault detection, which may help to ensure that any unintended current paths to ground are identified promptly.

The GFCI controller 513 may comprise a processing unit and/or a dedicated integrated circuit designed to implement ground fault circuit interrupter functionality. The GFCI controller 513 may comprise one or more input interfaces that may be configured for receiving current data from the current sensor 512. The GFC controller 513 may comprise one or more output interfaces for commanding the switching mechanisms. The GFCI Controller 513 may incorporate comparative logic and/or timing circuits that may operate to accurately detect current imbalances.

The GFCI controller 513 may be optionally included (or excluded) from the system/system 500B. If included, a primary function of the GFCI controller 513 may be to detect and interrupt potentially dangerous ground faults. The GFCI controller 513 may perform such operations by periodically (or constantly) monitoring the current flowing through the hot and neutral wires of the electrical circuit. The GFCI controller 513 may be configured to quickly trip, thereby cutting off the power and preventing a potentially harmful electrical shock, for example, if a difference in current is detected (e.g., which may indicate that electricity is flowing along an unintended path, such as through a person's body to the ground). In at least some examples, this operation of a GFCI controller 513 may provide a layer of electrical shock protection in addition to the temperature sensing and safety control described herein.

In at least some examples, the GFCI controller 513 may receive real-time current data from the current sensor 512. Based on its analysis of this current data, if a ground fault condition is identified, the GFCI controller 513 may send a trip signal to the switching driver 505. The switching driver 505 may then activate the switching 506 block to disconnect power to the outlet receptacle, thus interrupting the fault current. While integral for shock protection, it is noted that traditional GFCI functionality may not inherently protect against overheating at the terminals, which is specifically addressed by the thermal monitoring operations described herein.

Step 501 may comprise coupling to an external input. Step 502 may comprise coupling to an external output. Step 502 and/or step 507 may comprise one or more power management operations. Step 503, step 506, and/or step 505 may comprise one or more switching operations. Step 511 and/or step 508 may comprise one or more sensing operations. Step 504 and/or step 510 may comprise one or more smart feature operations.

While steps of FIG. 5A and FIG. 5B are shown with single arrow directions, signaling associated with any of these steps may be bi-directional, unidirectional in the direction shown, or unidirectional in an opposite direction as shown. For example, each arrow shown in FIG. 5A and/or FIG. 5B may be bi-directional, or uni-directional in either direction, and may correspond to input signaling and/or output signaling. Additionally, while steps of FIG. 5A and FIG. 5B are shown with numeric labels, any of the steps of FIG. 5A and/or FIG. 5B may be performed in any order (e.g., sequentially and/or in parallel), any number of times. One or more steps of FIG. 5A and/or FIG. 5B may be omitted or modified.

FIG. 6A and FIG. 6B show example back-side and front-side views, respectively, of an example of an apparatus and system for an electrical outlet with temperature monitoring and safety control. FIG. 6C shows additional example details of the apparatus and system of FIGS. 6A and 6B with an exploded view of the apparatus 400c.

In at least some examples, such as shown in FIGS. 6A-6C, the apparatus 400 described herein may comprise a tool-less wire insertion and clamp (e.g., such as in the form of the wire feed 420). For example, an apparatus 400c may be configured with an integrated, tool-less wire clamping mechanism to provide rapid, secure, and reliable termination of electrical conductors. The apparatus 400c may be configured with a main housing 460c that may be constructed from a high-dielectric strength, heat-resistant material, that may confirm to standard dimensions for installation in an electrical box. A front facing of the main housing may comprise a NEMA 14-50R receptacle configuration for accepting a corresponding plug. A rear portion of the main housing may comprise a termination system. For example, instead of conventional side-mounted screw terminals, a plurality of insertion points may be provided. For example, a plurality of wire insertion points, such as up to four (or more) clearly labeled wire insertion ports, may be provided, such as L1, L2, N (for neutral), and G (for ground). While FIG. 6A shows four wire insertion points (e.g., receiving wires 620), any other number of wire insertion points may be included. For example, in at least some examples, N (for neutral) may be omitted such that only three wire insertion points may be included in the apparatus 400c. Each port may be integrated with its own dedicated lever-actuated clamping mechanism (e.g., shown as 420C). Each clamping mechanism may comprise one or more of: a conductive bus bar, a spring clamp, and/or an actuating lever. The conductive bus bar may comprise a solid piece of tin-plated copper alloy that may serve as a primary electrical contact point and/or that may be electrically continuous with a corresponding blade receptacle on a face of an outlet (e.g., 413A). The spring clamp may comprise a stainless-steel material and/or may comprise a precision-formed spring that may be configured to exert a constant, high clamping force on a wire/conductor. The actuating lever may comprise a lever that, when lifted, may be configured to act on the spring (of the spring clamp) to open the clamping mechanism and to thereby create a clear insertion path for the wire/conductor.

The apparatus 400c may comprise one or more layers 670 (e.g., shown in FIG. 6C) upon which one or more components may be mounted. As examples, the one or more layers 670 may comprise one or more PCBs (e.g., 410 shown in FIGS. 4A-4E, and/or 410a and/or 410b shown in FIGS. 4F-4M) and/or one or more faceplates (e.g., 403B shown in FIGS. 4A-4E, and/or 403C shown in FIG. 4N). The apparatus 400c may comprise an enclosure 460c. The enclosure 460c may comprise a NEMA 14-50R receptacle, such as receptacle 403A. The receptacle 403A may comprise a plurality of portions such as shown in the exploded view of FIG. 6C. The enclosure 460c may be configured to be mate with a faceplate 610 such that electrical components of the apparatus 400c may not be exposed. The apparatus 400c may comprise a wire interface 420C. The wire interface 420C may comprise a wire feed such as described herein with respect to the wire feed 420A, descriptions of which are incorporated by reference. The wire interface 420C may be configured to receive one or more wires 620 without requiring opening of the apparatus 400c (e.g., without separating the faceplate 610 from the enclosure 460c). In such a manner, the apparatus 400c may be configured for fast and safe installation, such as by inserting of wires 620 (e.g., with ends of wires having insulation stripped) following by engaging clamps of the wire interface 420C to secure the respective wire in place. Within the wire interface 420C may be conductive elements to electrically connect a wire to a respective terminal within the apparatus 400c.

An apparatus may comprise a plurality of components for temperature monitoring and safety control, such as for an electrical outlet. The apparatus may comprise a plurality of wire connections collectively configured to receive a 220 to 277 volt alternating current (VAC) input power. The apparatus may comprise at least one temperature sensor. The apparatus may comprise at least one switch. The apparatus may comprise a plurality of bus bars. The apparatus may comprise an electrical receptacle electrically coupled to the plurality of bus bars and comprising a plurality of terminals collectively configured for providing a 220 to 277 VAC output power. The plurality of terminals may comprise: a first power terminal; a second power terminal; and a ground terminal. In at least some examples, the apparatus may comprise a neutral terminal. The apparatus may comprise a controller configured to selectively provide the 220 to 277 VAC output power to the plurality of terminals by performing one or more operations. The one or more operations may comprise: receiving an indication of a temperature from the at least one temperature sensor; and/or based on the indicated temperature satisfying a condition, controlling the at least one switch to disconnect a plurality of electrical connections between the 220 to 277 VAC input power and the plurality of terminals. The plurality of wire connections may comprise at least one of a wire feed or a terminal block. The at least one of the wire feed or the terminal block may be configured to receive a first power wire, a second power wire, and a ground wire. In at least some examples, the at least one of the wire feed or the terminal block may be configured to receive a neutral wire. The at least one of the wire feed or the terminal block may be configured to electrically couple the 220 to 277 VAC input power, directly or indirectly, to the at least one switch. The apparatus may further comprise a power converter configured to convert the 220 to 277 VAC input power to a direct current (DC) power. The controller may be configured to receive the DC power to selectively provide the 220 to 277 VAC output power to the plurality of terminals. The at least one temperature sensor may comprise a first temperature sensor associated with the first power terminal, and a second temperature sensor associated with the second power terminal. The at least one switch may comprise a first switch associated with the first power terminal, and a second switch associated with the second power terminal. The controller may be configured to control the at least one switch to disconnect the plurality of electrical connections between the 220 to 277 VAC input power and the plurality of terminals by at least one of: based on an indicated temperature received from the first temperature sensor satisfying a first condition: disconnecting, by the first switch, an electrical connection between the plurality of wire connections and the first power terminal; and based on an indicated temperature received from the second temperature sensor satisfying a second condition: disconnecting, by the second switch, an electrical connection between the plurality of wire connections and the second power terminal. The apparatus may further comprise a plurality of printed circuit boards (PCBs). The plurality of PCBs may comprise: a first printed circuit board (PCB); and a second PCB. The first PCB may comprise the at least one temperature sensor and the at least one switch. The second PCB may comprise at least one wireless communications device configured to wirelessly communicate with an external device. The apparatus may comprise a wall mountable enclosure that may be configured to enclose at least one of: the at least one temperature sensor; the at least one switch; the plurality of bus bars; at least three sides of the electrical receptacle; and the controller. The wall mountable enclosure may comprise one or more of a dual-gang, a 2-to-4 gang box, an external wall mount device, a conduit box, a junction box, a receptacle assembly, and/or any certified electrical enclosure. The plurality of bus bars may comprise: a first bus bar electrically coupled to the first power terminal; a second bus bar electrically coupled to the second power terminal; and a third bus bar electrically coupled to the ground terminal. In at least some examples, the plurality of bus bars may additionally comprise a fourth bus bar electrically coupled to a neutral ground terminal. The electrical receptacle may be a first electrical receptacle. The apparatus may further comprise: a second electrical receptacle; and a splitter configured to couple the 220 to 277 VAC input power to both the first electrical receptacle and the second electrical receptacle. The controller may be configured to selectively provide a 220 to 277 VAC output power to a plurality of terminals of the second electrical receptacle by controlling the at least one switch to: based on the indicated temperature satisfying the condition, disconnect a plurality of electrical connections between the 220 to 277 VAC input power and the plurality of terminals of the second electrical receptacle. The controller may be configured to selectively provide the 220 to 277 VAC output power to the plurality of terminals by reconnecting the plurality of electrical connections between the 220 to 277 VAC input power and the plurality of terminals based on at least one of: an expiration of a timer; a time duration after the disconnect of the plurality of electrical connections between the 220 to 277 VAC input power and the plurality of terminals; receiving a second indication of a temperature from the at least one temperature sensor, wherein the second indicated temperature does not satisfy the condition; or manual engagement of a reset switch. The apparatus may further comprise: a current sensor; and a ground-fault circuit interrupt (GFCI). The GFCI may be configured to: receive at least one indication of at least one current measurement from the current sensor; and cause the at least one switch to interrupt a flow of electrical power from the 220 to 277 VAC input power to the electrical receptacle. The at least one switch may comprise at least one of: a metal-oxide semiconductor field effect transistors (MOSFET); or a gallium nitride field effect transistor (FET). The 220 to 227 VAC input power may be 240 VAC with a tolerance of +/−5%. The 220 to 277 VAC output power may be 240 VAC with a tolerance of +/−5%. The indication of the temperature from the at least one temperature sensor may be a second indication of a second temperature. The condition may comprise a temperature threshold. The controller may be configured to selectively provide the 220 to 277 VAC output power to the plurality of terminals by: receiving a plurality of indications of temperatures from the at least one temperature sensor, wherein the plurality of indications of temperatures comprises a first indication of a first temperature and the second indication of the second temperature; based on the first indicated temperature being less than the temperature threshold, controlling the at least one switch to electrically connect the 220 to 277 VAC input power and the plurality of terminals; and based on the second indicated temperature being greater than or equal to the temperature threshold, controlling the at least one switch to disconnect the plurality of electrical connections between the 220 to 277 VAC input power and the plurality of terminals.

An apparatus may comprise a plurality of components for temperature monitoring and safety control, such as for an electrical outlet. The apparatus may comprise: a plurality of wire connections collectively configured to receive a 220 to 277 volt alternating current (VAC) input power; at least one temperature sensor; at least one switch; a plurality of bus bars; and an electrical receptacle electrically coupled to the plurality of bus bars and comprising a plurality of terminals collectively configured for providing a 220 to 227 VAC output power. The plurality of terminals may comprise: a first power terminal; a second power terminal; and a ground terminal. In at least some examples, the plurality of terminals may additionally comprise a neutral terminal. The apparatus may comprise a controller configured to selectively provide the 220 to 277 VAC output power to the plurality of terminals by controlling the at least one switch to: electrically connect the 220 to 277 VAC input power to the plurality of terminals, if the at least one temperature sensor indicates a measured temperature less than a threshold; and electrically disconnect the 220 to 277 VAC input power to the plurality of terminals, if the at least one temperature sensor indicates a measured temperature greater than or equal to the threshold. The apparatus may comprise a wireless transceiver configured to: transmit at least one indication of a temperature measurement indicated by the at least one temperature sensor; and receive at least one command to control an operation of at least one of the controller or the at least one switch. The apparatus may comprise a plurality of printed circuit boards (PCBs). The plurality of PCBs may comprise a first printed circuit board (PCB), and a second PCB. The first PCB may comprise the at least one temperature sensor and the at least one switch. The second PCB may comprise the wireless transceiver. The controller may be configured to selectively provide the 220 to 277 VAC output power to the plurality of terminals by controlling the at least one switch to: electrically disconnect a plurality of electrical connections between the 220 to 277 VAC input power and the plurality of terminals, based on the at least one temperature sensor indicating a measured temperature greater than or equal to the threshold.

A system may be provided for temperature monitoring and safety control, such as for an electrical outlet. The system may comprise an apparatus configured to provide a 220 to 277 VAC output power; and a control device configured to wirelessly communicate with the apparatus. The apparatus may comprise: a plurality of wire connections collectively configured to receive a 220 to 277 volt alternating current (VAC) input power; at least one temperature sensor; at least one switch; a plurality of bus bars; and an electrical receptacle electrically coupled to the plurality of bus bars and comprising a plurality of terminals collectively configured for providing a 220 to 227 VAC output power. The plurality of terminals may comprise: a first power terminal; a second power terminal; and a ground terminal. In at least some examples, the plurality of terminals may additionally comprise a neutral terminal. The apparatus may comprise a controller configured to selectively provide the 220 to 277 VAC output power to the plurality of terminals by controlling the at least one switch to: electrically connect the 220 to 277 VAC input power to the plurality of terminals, if the at least one temperature sensor indicates a measured temperature less than a threshold; and electrically disconnect the 220 to 277 VAC input power to the plurality of terminals, if the at least one temperature sensor indicates a measured temperature greater than or equal to the threshold. The control device may comprise a smart breaker configured for installation in an electrical panel. The smart breaker may be configured to transmit at least one command to control an operation of at least one of the controller or the at least one switch of the apparatus. The apparatus may comprise a wireless transceiver configured to transmit, to the control device, at least one indication of a temperature measurement indicated by the at least one temperature sensor. The system may comprise a user interface configured to: display an indication of a temperature measurement indicated by the at least one temperature sensor; receive an input of a user-selectable operation of the apparatus; and send a command to the controller of the apparatus for implementation of the user-selectable operation.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. An apparatus comprising:
a plurality of wire connections collectively configured to receive a 220 to 277 volt alternating current (VAC) input power;
at least one temperature sensor;
at least one switch;
a plurality of bus bars;
an electrical receptacle electrically coupled to the plurality of bus bars and comprising a plurality of terminals collectively configured for providing a 220 to 277 VAC output power, wherein the plurality of terminals comprises:
a first power terminal;
a second power terminal; and
a ground terminal; and
a controller configured to selectively provide the 220 to 277 VAC output power to the plurality of terminals by:
receiving an indication of a temperature from the at least one temperature sensor; and
based on the indicated temperature satisfying a condition, controlling the at least one switch to disconnect a plurality of electrical connections between the 220 to 277 VAC input power and the plurality of terminals.

2. The apparatus of claim 1, wherein the plurality of wire connections comprises at least one of a wire feed or a terminal block, wherein the at least one of the wire feed or the terminal block is configured to:
receive a first power wire, a second power wire, and a ground wire; and
electrically couple the 220 to 277 VAC input power, directly or indirectly, to the at least one switch.

3. The apparatus of claim 1, wherein the apparatus further comprises a power converter configured to convert the 220 to 277 VAC input power to a direct current (DC) power, and wherein the controller is configured to receive the DC power to selectively provide the 220 to 277 VAC output power to the plurality of terminals.

4. The apparatus of claim 1, wherein:
the at least one temperature sensor comprises a first temperature sensor associated with the first power terminal, and a second temperature sensor associated with the second power terminal; and
the at least one switch comprises a first switch associated with the first power terminal, and a second switch associated with the second power terminal; and
the controller is configured to control the at least one switch to disconnect the plurality of electrical connections between the 220 to 277 VAC input power and the plurality of terminals by at least one of:
based on an indicated temperature received from the first temperature sensor satisfying a first condition: disconnecting, by the first switch, an electrical connection between the plurality of wire connections and the first power terminal; and
based on an indicated temperature received from the second temperature sensor satisfying a second condition: disconnecting, by the second switch, an electrical connection between the plurality of wire connections and the second power terminal.

5. The apparatus of claim 1, further comprising a plurality of printed circuit boards (PCBs), wherein the plurality of PCBs comprises:
a first printed circuit board (PCB); and
a second PCB, wherein:
the first PCB comprises the at least one temperature sensor and the at least one switch; and
the second PCB comprises at least one wireless communications device configured to wirelessly communicate with an external device.

6. The apparatus of claim 1, wherein the apparatus further comprises wall mountable enclosure that is configured to enclose at least one of:
the at least one temperature sensor;
the at least one switch;
the plurality of bus bars;
at least three sides of the electrical receptacle; and
the controller.

7. The apparatus of claim 1, wherein the plurality of bus bars comprises:
a first bus bar electrically coupled to the first power terminal;
a second bus bar electrically coupled to the second power terminal; and
a third bus bar electrically coupled to the ground terminal.

8. The apparatus of claim 1, wherein the electrical receptacle is a first electrical receptacle, and wherein the apparatus further comprises:
a second electrical receptacle; and a
splitter configured to couple the 220 to 277 VAC input power to both the first electrical receptacle and the second electrical receptacle.

9. The apparatus of claim 8, wherein the controller is further configured to selectively provide a 220 to 277 VAC output power to a plurality of terminals of the second electrical receptacle by controlling the at least one switch to:
based on the indicated temperature satisfying the condition, disconnect a plurality of electrical connections between the 220 to 277 VAC input power and the plurality of terminals of the second electrical receptacle.

10. The apparatus of claim 1, wherein the controller is further configured to selectively provide the 220 to 277 VAC output power to the plurality of terminals by:
reconnecting the plurality of electrical connections between the 220 to 277 VAC input power and the plurality of terminals based on at least one of:
an expiration of a timer;
a time duration after the disconnect of the plurality of electrical connections between the 220 to 277 VAC input power and the plurality of terminals;
receiving a second indication of a temperature from the at least one temperature sensor, wherein the second indicated temperature does not satisfy the condition; or
manual engagement of a reset switch.

11. The apparatus of claim 1, further comprising:
a current sensor; and
a ground-fault circuit interrupt (GFCI) configured to:
receive at least one indication of at least one current measurement from the current sensor; and
cause the at least one switch to interrupt a flow of electrical power from the 220 to 277 VAC input power to the electrical receptacle.

12. The apparatus of claim 1, wherein the at least one switch comprises at least one of:
a metal-oxide semiconductor field effect transistors (MOSFET); or
a gallium nitride field effect transistor (FET).

13. The apparatus of claim 1, wherein the 220 to 227 VAC input power is 240 VAC with a tolerance of +/−5%, and wherein the 220 to 277 VAC output power is 240 VAC with a tolerance of +/−5%.

14. The apparatus of claim 1, wherein the indication of the temperature from the at least one temperature sensor is a second indication of a second temperature, the condition comprises a temperature threshold, and the controller is further configured to selectively provide the 220 to 277 VAC output power to the plurality of terminals by:
receiving a plurality of indications of temperatures from the at least one temperature sensor, wherein the plurality of indications of temperatures comprises a first indication of a first temperature and the second indication of the second temperature;
based on the first indicated temperature being less than the temperature threshold, controlling the at least one switch to electrically connect the 220 to 277 VAC input power and the plurality of terminals; and
based on the second indicated temperature being greater than or equal to the temperature threshold, controlling the at least one switch to disconnect the plurality of electrical connections between the 220 to 277 VAC input power and the plurality of terminals.

15. An apparatus comprising:
a plurality of wire connections collectively configured to receive a 220 to 277 volt alternating current (VAC) input power;
at least one temperature sensor;
at least one switch;
a plurality of bus bars;
an electrical receptacle electrically coupled to the plurality of bus bars and comprising a plurality of terminals collectively configured for providing a 220 to 227 VAC output power, wherein the plurality of terminals comprises:
a first power terminal;
a second power terminal; and
a ground terminal; and
a controller configured to selectively provide the 220 to 277 VAC output power to the plurality of terminals by controlling the at least one switch to:
electrically connect the 220 to 277 VAC input power to the plurality of terminals, if the at least one temperature sensor indicates a measured temperature less than a threshold; and
electrically disconnect the 220 to 277 VAC input power to the plurality of terminals, if the at least one temperature sensor indicates a measured temperature greater than or equal to the threshold.

16. The apparatus of claim 15, further comprising a wireless transceiver configured to:
transmit at least one indication of a temperature measurement indicated by the at least one temperature sensor; and
receive at least one command to control an operation of at least one of the controller or the at least one switch.

17. The apparatus of claim 15, wherein the controller is further configured to selectively provide the 220 to 277 VAC output power to the plurality of terminals by controlling the at least one switch to:
electrically disconnect a plurality of electrical connections between the 220 to 277 VAC input power and the plurality of terminals, based on the at least one temperature sensor indicating a measured temperature greater than or equal to the threshold.

18. A system comprising:
an apparatus configured to provide a 220 to 277 VAC output power; and
a control device configured to wirelessly communicate with the apparatus, wherein:
the apparatus comprises:
a plurality of wire connections collectively configured to receive a 220 to 277 volt alternating current (VAC) input power;
at least one temperature sensor;
at least one switch;
a plurality of bus bars;
an electrical receptacle electrically coupled to the plurality of bus bars and comprising a plurality of terminals collectively configured for providing a 220 to 227 VAC output power, wherein the plurality of terminals comprises:
a first power terminal;
a second power terminal; and
a ground terminal; and
a controller configured to selectively provide the 220 to 277 VAC output power to the plurality of terminals by controlling the at least one switch to:
electrically connect the 220 to 277 VAC input power to the plurality of terminals, if the at least one temperature sensor indicates a measured temperature less than a threshold; and
electrically disconnect the 220 to 277 VAC input power to the plurality of terminals, if the at least one temperature sensor indicates a measured temperature greater than or equal to the threshold.

19. The system of claim 18, wherein:
the control device comprises a smart breaker configured for installation in an electrical panel, wherein the smart breaker is further configured to transmit at least one command to control an operation of at least one of the controller or the at least one switch of the apparatus; and
the apparatus further comprises a wireless transceiver configured to transmit, to the control device, at least one indication of a temperature measurement indicated by the at least one temperature sensor.

20. The system of claim 18, wherein the system further comprises a user interface configured to:
display an indication of a temperature measurement indicated by the at least one temperature sensor;
receive an input of a user-selectable operation of the apparatus; and
send a command to the controller of the apparatus for implementation of the user-selectable operation.
